(19) United States
(12) Patent Application Publication
(10) Pub. No.: US 2019/0179877 A1
(43) Pub. Date: Jun. 13, 2019

(54) INFORMATION PROCESSING SYSTEM, CONTROL METHOD, AND STORAGE MEDIUM

(71) Applicant: CANON KABUSHIKI KAISHA, Tokyo (JP)

(72) Inventor: Yutaka Kato, Tokyo (JP)

(21) Appl. No.: 16/215,367

(22) Filed: Dec. 10, 2018

(30) Foreign Application Priority Data
Dec. 12, 2017 (JP) 2017-238086

(51) Int. Cl. G06F 17/21; G06F 17/24

(52) U.S. Cl. CPC G06F 17/212; G06F 17/243

(57) ABSTRACT

One aspect of the present invention is an information processing system configured to change a display of a graph based on output data changed by a user operation.

### BACKGROUND

### Field of the Disclosure

The present disclosure relates to an information processing system that displays a form, a control method, and a storage medium therefor.

### Description of the Related Art

There has been the following method as a method for generating a form. That is, a form file serving as a template of the form is generated in advance using a special application (a form file editor), and field data is overlaid on the form file. In other words, corresponding field data is applied to each field in the form file by being inserted therein. By this insertion, the form (for example, a file in the Portable Document Format (PDF) format) is generated. When the form is printed, a client apparatus causes a printer to print the form generated by carrying out the overlay on a server.

In this manner, originally, usage of the form has been mostly limited to using the form by printing it. However, in recent years, it has become increasingly common to display the form on a device such as a tablet device and a personal computer (PC) and print only necessary output pages thereof with the aim of saving paper resources. One specific example of this usage is presenting an insurance form to a customer using the device such as the tablet device and the PC.

The form displayed on the device may contain not only a table but also a graph. For example, in the case of the insurance form, one possible usage is displaying table data as a graph for the purpose of smoothly explaining the insurance form to the customer and creating a visual impact of a product. In this case, there emerges such a demand that users want to change a price of the product (for example, an insurance premium) to a discount price in the middle of the explanation and reflect this insurance premium into the graph. Japanese Patent Application No. 2012-286542 discusses a graph generation program that determines a graph type according to a purpose for the generation and generates the determined type of graph.

### SUMMARY

The present disclosure has been made in consideration of the above-described object, and one aspect thereof is an information processing system characterized by including the following units. That is, the information processing system includes a client apparatus including a web browser, and a form generation server configured to provide a form displayed on the web browser. The form generation server includes a provision unit configured to provide a program for identifying a position of changed output data in the form and updating a currently displayed graph according to the change in the output data. The web browser of the client apparatus executing the program provided by the provision unit includes a determination unit configured to identify the graph related to the changed output data and determine whether a field contained in the identified graph and a field at the position match each other, and a change unit configured to change the display of the graph based on the output data changed by a user operation according to the determination unit determining that the field contained in the identified graph and the field at the position match each other.

Further features of the present disclosure will become apparent from the following description of exemplary embodiments with reference to the attached drawings.

### BRIEF DESCRIPTION OF THE DRAWINGS

FIG. 1 illustrates an example of a configuration of an information processing system according to one or more aspects of the present disclosure.

FIG. 2 illustrates an example of a hardware configuration according to one or more aspects of the present disclosure.

FIG. 3 illustrates functions included in a form generation server according to one or more aspects of the present disclosure.

FIG. 4 is a conceptual diagram of overlay processing.

FIG. 5 is a sequence diagram of processing for generating web form view information.

FIG. 6 illustrates a login screen.

FIG. 7 illustrates a form selection screen.

FIG. 8 is a sequence diagram of the overlay processing.

FIG. 9 illustrates one example of output page information.

FIGS. 10A and 10B illustrate one example of form files constituting a combined form file.

FIG. 11 illustrates one example of a graph attribute of a graph.

FIG. 12 illustrates one example of field data.

FIG. 13 illustrates an example of a structure of an output page in a Scalable Vector Graphics (SVG) format.

FIG. 14 is a sequence diagram of graph generation processing according to one or more aspects of the present disclosure.

FIG. 15A illustrates one example of a program for performing the graph generation processing according to the first exemplary embodiment. FIG. 15B illustrates one example of a program for performing processing for assigning identification information according to the first exemplary embodiment. FIG. 15C is a sequence diagram illustrating processing for performing the processing for assigning the identification information according to one or more aspects of the present disclosure.

FIG. 16 illustrates one example of an output page (SVG) after the identification information is assigned according to one or more aspects of the present disclosure.

FIG. 17 illustrates one example of a screen display generated based on the web form view information.

FIG. 18, which includes FIGS. 18A and 18B, illustrates an example of a structure of a generated graph in the SVG format according to one or more aspects of the present disclosure.

FIG. 19 is a sequence diagram of graph update processing according to one or more aspects of the present disclosure.

FIG. 20 illustrates one example of a program for performing the graph update processing according to one or more aspects of the present disclosure.

FIG. 21 illustrates one example of a screen display after the update according to one or more aspects of the present disclosure.

FIG. 22 illustrates one example of a screen display generated based on the web form view information according to one or more aspects of the present disclosure.

FIG. 23 illustrates one example of output page information according to one or more aspects of the present disclosure.

FIG. 24 is a sequence diagram of graph generation processing according to one or more aspects of the present disclosure.

### DESCRIPTION OF THE EMBODIMENTS

In the technique discussed in Japanese Patent Application No. 2012-286542, the server needs to regenerate an image of the graph according to the change in the data. It is not necessarily desirable for the client apparatus to inquire of the server every time the graph is regenerated from a viewpoint of a network bandwidth.

Further, it is difficult to change the form displayed by a web browser in response to a general-purpose user operation.

The present disclosure is directed to allowing the web browser to update the display of the form according to the changed value.

In the following description, exemplary embodiments of the present disclosure will be described with reference to the drawings. First, terms used in the present disclosure will be described.

### Term Definition

Form File

A file defining information serving as a template of the form. The form file is edited using a special form file design editor. The form file also contains definitions of a fixed character string such as an address of a company possessing the form, and an image of a company logo of this company. The term form in the present exemplary embodiments will refer to a graph and a table for outputting and displaying data (field data, which will be described below).

Field

A field is an element that receives variable data (the field data, which will be described below), and is defined in the form file. The field is associated with the field data based on a name owned by the field.

Field Object

An object defined in the form file, and used to output the variable data (the field data, which will be described below) inserted into the field. Information regarding an appearance such as a font size is not set to the field but is set to the field object. The field and the field object are associated with each other in the form file.

Field Data

Data in a text format that is inserted into the field in the form file. For example, if the field is “country”, individual raw data inserted into it, such as “Japan” and “Italy”, is the field data.

Field Data File

A file in which a plurality of pieces of field data is collected.

Graph Attribute

A graph attribute is an attribute regarding the graph that is owned by a graph object. The graph object refers to an object for drawing the graph defined in the form file, and is one type of the field object. The graph object has a definition of the field used in the graph, and a definition of information controlling an appearance such as a type of the graph and a color of a line graph, and is stored in the form file.

Overlay

Overlay means inserting the field data into the field, performing layout processing in consideration of the font size and the like defined in the field object, superimposing the form file and the field data and outputting an output page. The overlaid data can be output not only onto paper but also as an electronic file, and the term “overlay” will be used to refer to printing the data or generating a document such as PDF in the present disclosure.

Output Page

Each page in the printout or the document output as a result of the overlay. Examples of a format therefor include PDF and Scalable Vector Graphics (SVG).

Output Data

Data output onto the output page as a result of the overlay.

Output Page Information

Information regarding the output page containing the output data. The output page information has, for example, an output coordinate of each piece of output data. The output page information is used at the time of construction of web form view information, which will be described below.

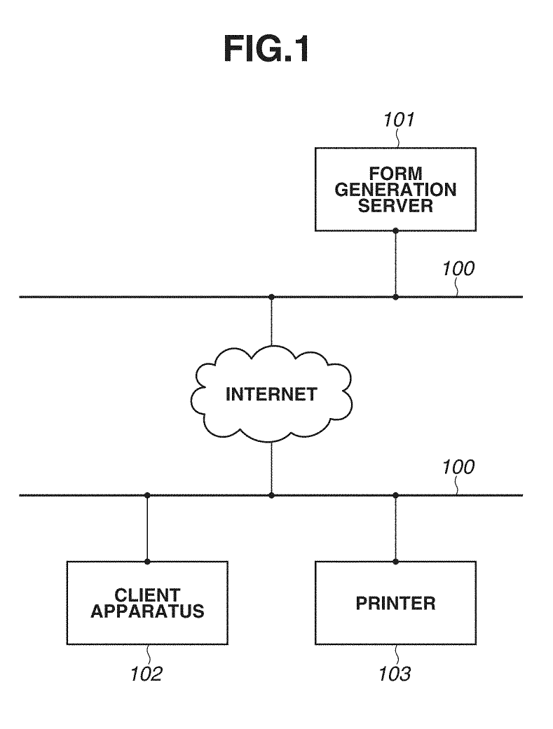

FIG. 1 illustrates an example of a configuration of an information processing system according to the present exemplary embodiments. The information processing system illustrated in FIG. 1 includes a form generation server 101 and a client apparatus 102. The form generation server 101 performs the overlay processing and processing for generating the web form view information. More specifically, the form generation server 101 superimposes field data 406, which is text data, and a predetermined form file 401 to generate the output page, and instructs a printer driver to generate this output page as the electronic file. Then, the form generation server 101 generates the web form view information that allows the form to be viewed using the generated electronic file. The web form view information refers to a web application running on a web browser that can be distributed via a network. In many cases, such a web application operates according to a markup language (Hyper Text Markup Language (HTML)) expressing a web page and a programming language (JavaScript (registered trademark)) running on the web browser. The information processing system may be configured in such a manner that the form generation server 101 generates only the output page and a file storing the output page information therein, and the client apparatus 102 displays the web form view information using this file.

The client apparatus 102 receives the web form view information or information required to draw the graph from the form generation server 101, and displays the form. Further, the client apparatus 102 detects a user operation, and updates the drawn graph according to the detected user operation. Specific examples of the client apparatus 102 include a terminal such as a tablet terminal and a PC. The user operation refers to a touch operation onto a display screen in the case where the client apparatus 102 is the tablet terminal, and is, for example, an input operation using a keyboard in the case where the client apparatus 102 is the PC. In the following description, for convenience of the description, the present exemplary embodiments will be described based on an example assuming that the client apparatus 102 is the table terminal. A printer 103 receives a request from the client apparatus 102, and prints a file of the form.

These apparatuses 101 to 103 are communicably connected to one another via a network 100. The network 100 may be any type of network as long as data can be transmitted and received via it. Further, communication from the client apparatus 102 to the form generation server 101, and communication from the client apparatus 102 to the printer 103 may be carried out by different methods from each other.

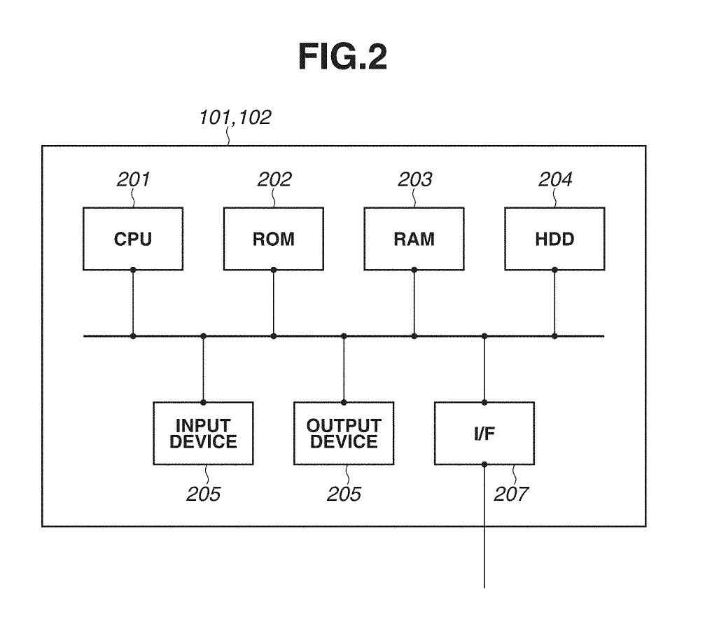

FIG. 2 is a block diagram illustrating a hardware configuration of the form generation server 101 and the client apparatus 102. In the present example, for convenience of the description, the hardware configuration will be described based on the form generation server 101 by way of example.

A central processing unit (CPU) 201 is a unit that controls the form generation server 101 by extracting a program from a read only memory (ROM) 202, a random access memory (RAM) 203, or the like, and executing a command of the program. Sequences that will be described below are realized by the execution of the command of this program. Further, the CPU 201 controls each of blocks connected to an internal bus. The ROM 202 is a storage device recording therein an application program and an operating system (OS), a built-in program including a basic input/output system (BIOS), data, and the like.

The RAM 203 is a work memory used when the CPU 201 executes the command. The CPU 201 executes the command by loading a program such as the OS or the application stored in the ROM 202 or the like into the RAM 203, and sequentially reading out a command of this program.

A hard disk drive (HDD) 204 is a storage device storing therein the OS, which is fundamental software, and a software module, and may be an indirect storage device such as a solid state drive (SSD).

An input device 205 is, for example, a not-illustrated keyboard and pointing device. A display is connected to an output device 206. An interface (I/F) 207 is an interface for connecting the form generation server 101 and the network 100 to each other.

After the form generation server 101 is started up, the BIOS is executed by the CPU 201 and the OS is loaded from the HDD 204 into the RAM 203 so as to be executable. The CPU 201 loads various kinds of software modules that will be described below from the HDD 204 into the RAM 203 so that they can be executed according to an operation of the OS as needed.

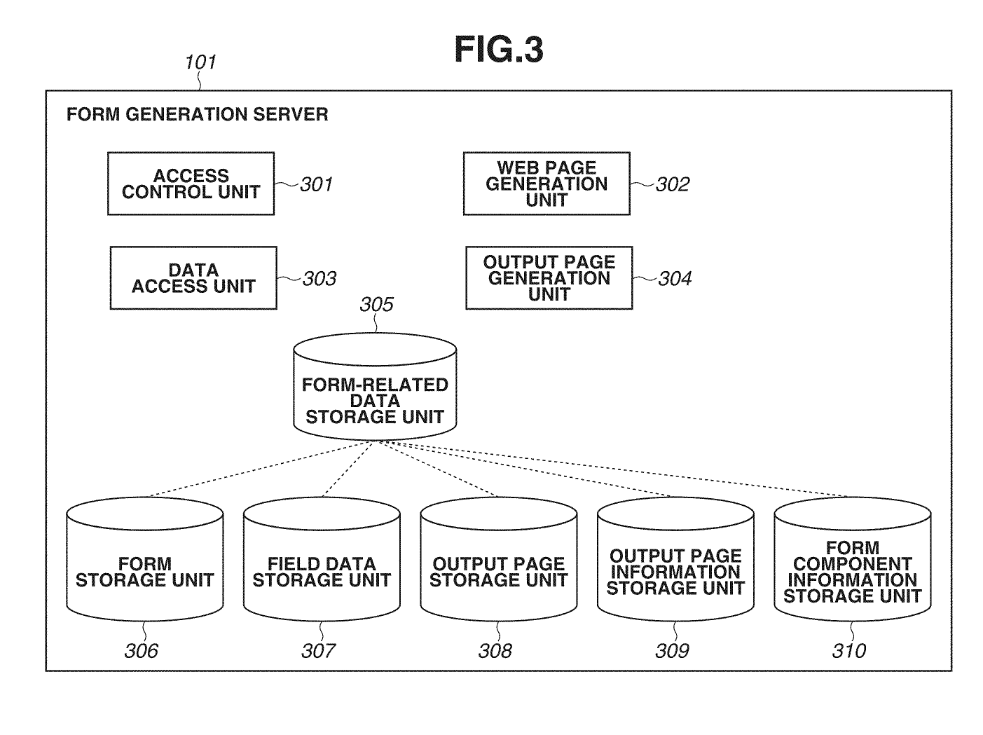

FIG. 3 illustrates functions included in the form generation server 101. Programs of various kinds of functions are stored in the HDD 204, and are executed by being loaded into the RAM 203 by the CPU 201.

An access control unit 301 is a function of authenticating a user according to a request from the client apparatus 102. A web page generation unit 302 is a function of generating a web page to be returned to the client apparatus 102 as a response. A file such as HTML and JavaScript required for a web application that is the web form view information is also generated by the web page generation unit 302, and is returned to the client apparatus 102. A data access unit 303 is a function of accessing each of form-related data storage units 305 to 310.

An output page generation unit 304 is a function of superimposing the form file 401 and the field data 406 read out from a database via the data access unit 303, thereby generating print data. Further, the output page generation unit 304 generates the electronic file of the output page using software such as the printer driver from the generated print data. The output page generation unit 304 also has a function of further converting this electronic file into another file format such as SVG.

The form-related data storage unit 305 stores form-related data therein. The form-related data refers to information regarding the form, such as a form name and an owner. Further, the form-related data storage unit 305 manages the form, the form file, and the field data in association with one another. Further, the form-related data storage unit 305 manages the form, the output page, which is a result of the overlay, and the output page information, which will be described below, in association with one another. Use of the form-related data storage unit 305 allows, for example, some output page to be identified about which form file this output page is generated from.

A form storage unit 306 stores the form file therein. A field data storage unit 307 stores the field data therein. An output page storage unit 308 stores the output page generated by the output page generation unit 304 therein. An output page information storage unit 309 stores the output page information generated by the overlay processing therein. A form component information storage unit 310 stores form component information therein. The form component information includes information of, for example, a focus function for enlarging a part of the form, but a detailed description of the form component information will be omitted herein.

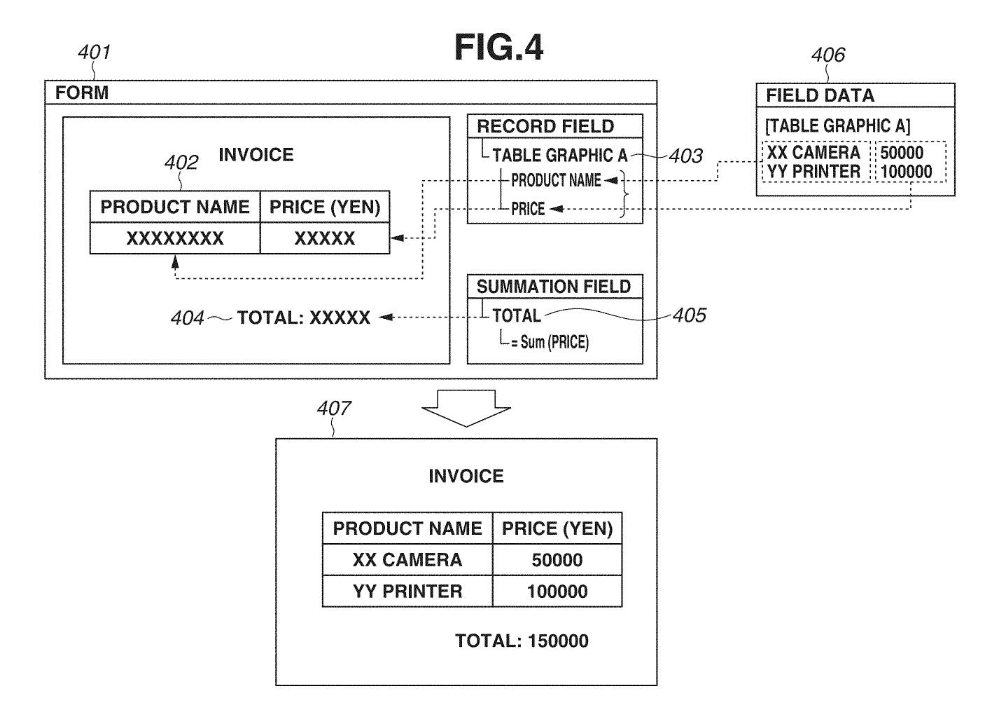

Next, commonly practiced overlay processing will be described in detail. FIG. 4 schematically illustrates the overlay processing by the form generation server 101. The form file is generated using the special form file design editor, and is stored as a file. Generally, the form file includes a fixed object independent of the field data (a form object), and the field object that displays the received field data according to a specified output format. Specific examples of the form object include an object containing fixed information such as a logo of a company and contact information used when the form or the like is generated.

The field, which is the element for receiving the field data, should be generated in advance to generate the field object. The field can be generated from a special screen of the form file design editor. When being generated, the field object is associated with the field, which is a generation source of this field object.

For example, when a field object (a table object) 402 in a table format is generated, the field object 402 is associated with a record field 403, which is a generation source of this table object 402. The record field 403 is a field for receiving the field data record by record. Further, when a field object 404 is generated, the field object 404 is associated with a summation field 405, which is a generation source of this field object 404. The summation field 405 is a field specifying what kind of summation method is performed to generate the field data.

The form generation server 101 reads in the form file 401 in which the field object is defined, and the field data 406 corresponding to this field object. Then, the form generation server 101 carries out the overlay by superimposing the read form 401 and field data 406, and then an output result 407 of the overlay is output. This is one example of the overlay processing performed by the form generation server 101.

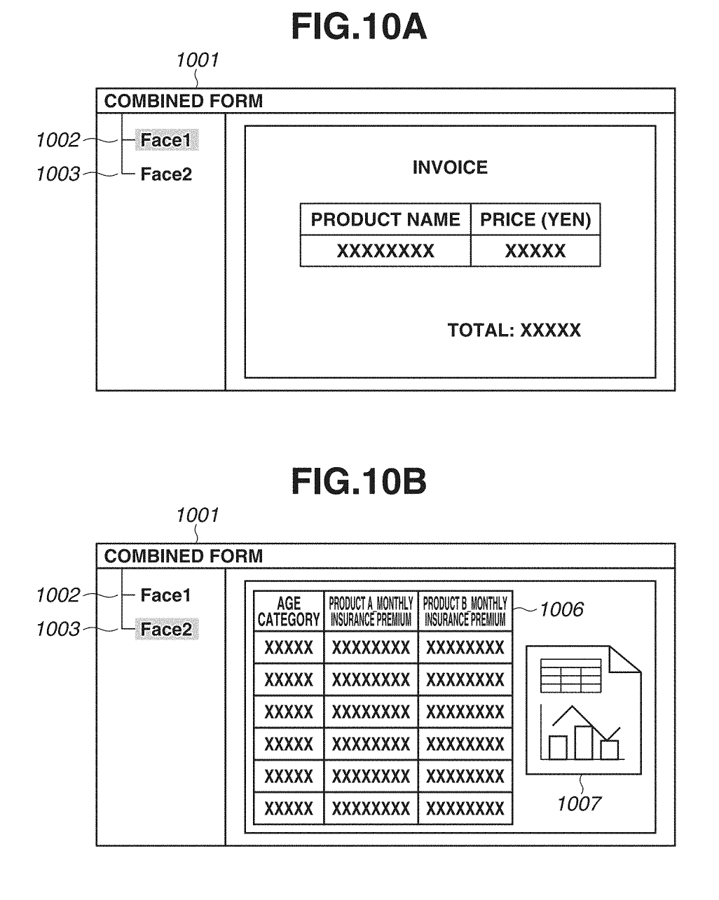

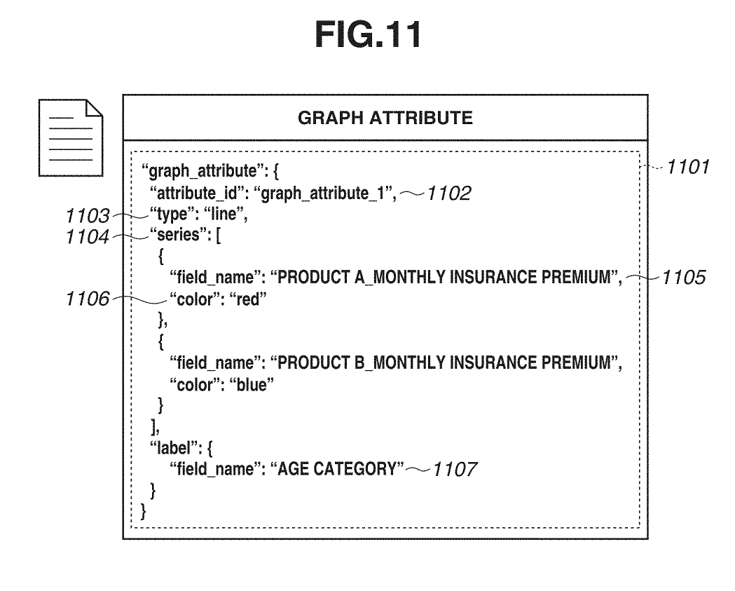

Next, processing for editing a combined form file will be described with reference to FIGS. 10A and 10B, and 11. The combined form file refers to information for outputting several form files all together as one form file. Generating the combined form file allows the user to output the form while switching the plurality of form files contained in the combined form file.

First, the form files constituting the combined form file will be described with reference to FIGS. 10A and 10B. A combined form file 1001 can be generated and stored by using the form file design editor. In the present example, the combined form file 1001 will be described assuming that the combined form file 1001 is constituted by a plurality of form files (1002 and 1003). A definition of each of the form files defined in the combined form file will be referred to as a “face”, and is also a unit based on which the form file displayed in FIGS. 10A and 10B is switched. Each face has a name (a face name) unique in the combined form file. In the present example, assume that the face name of the form file 1002 is “Face 1”, and the face name of the form file 1003 is “Face 2”.

Each of the form files defined in the combined form file can be confirmed on a screen by using the form file design editor. For example, in FIG. 10A, when “Face 1” is selected, an icon of the form file 1002 in a face list tree in a left pane is highlighted, which clearly indicates that the form file 1002 is currently selected. A content of Face 1 is displayed in a right pane, which is the other pane. Subsequently, in FIG. 10B, when “Face 2” is selected, an icon of the form file 1003 in the left pane is highlighted, and a content of Face 2 is displayed in the right pane.

With the form file selected in the left pane, the form file design editor allows the user to further edit the content of this form file. For example, a table object 1006 and a graph 1007 are defined in the content of the form file 1003 (Face 2). The table object 1006 includes three fields, namely, “age category”, “product A_monthly insurance premium”, and “product B_monthly insurance premium”, and field objects generated from these fields. The form file 1003 is prepared in a format of receiving the field data record by record, and is set so as to display the field data corresponding to six records (six rows) on one page. The graph 1007 is a graph in which the data in the table object 1006 is graphed. In the present example, the field data inserted into the “age category” field is drawn as an X-axis label of the graph, and the graph is drawn based on the field data inserted into the “product A_monthly insurance premium” field and the “product B_monthly insurance premium” field.

Next, a graph attribute will be described with reference to FIG. 11. A setting of the graph is saved in the form file as a “graph attribute” when the form file is stored by the form file design editor. In the present example, the graph attribute is indicated in the JavaScript Object Notation (JSON) format, but is not limited to this format.

A graph attribute 1101 indicates an attribute regarding the graph 1007 contained in the form file 1003. In the graph attribute 1101, “attribute_id” is a graph attribute identifier 1102, which is an identifier for distinguishing the graph attribute, and is uniquely identified in the form file 1003. Further, “type” is a graph type 1103. In the present example, “line”, which specifies a polygonal line graph, is set to the graph type 1103. Further, “series” is specified series data 1104 plotted on the graph. In the present example, detailed settings regarding two pieces of series data are specified. More specifically, “field_name” is a name 1105 of the field used as the series data, and “color” is a color setting 1106 when the series data is displayed as a polygonal line. In the present example, the specified series data 1104 is set in such a manner that the graph is created by plotting data of the “product A_monthly insurance premium” field with a red polygonal line and plotting data of the “product B_monthly insurance premium” field with a blue polygonal line.

Further, “label” is a name 1107 of a label field used as the X-axis label of the graph, and the “age category” field is set in the present example. In the overlay processing, the read field data is inserted into the three fields, namely, “age category”, “product A_monthly insurance premium”, and “product B_monthly insurance premium”. In the case of the graph 1007, the graph is generated according to the graph attribute 1101 thereof and the field objects associated with the three fields included in the table object 1006. The form containing the table and the graph linked to the form file is generated in this manner.

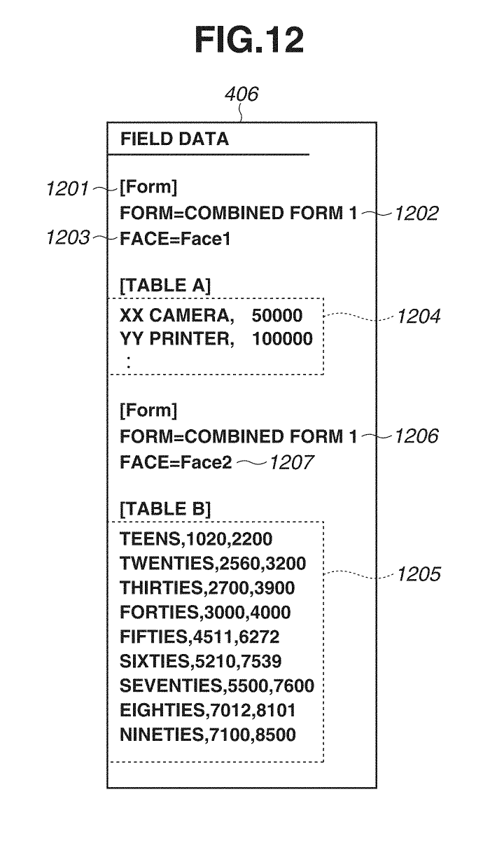

Next, the field data 406 to be inserted into the combined form file 1001 will be described with reference to FIG. 12. FIG. 12 illustrates one example of the field data 406. A form file switching instruction 1202 and a face switching instruction 1203 are defined in a form file-related definition 1201. When reading in the field data 406, the form generation server 101 interprets each instruction and identifies a form file and a face to insert the data into according to the form file-related definition 1201. In FIG. 12, “combined form 1” and “Face 1” are set to the form file switching instruction 1202 and the face switching instruction 1203, respectively, so that a data block 1204 is inserted into a table A defined in the form file of “Face 1” of “combined form 1”. The table A corresponds to the table indicated in the right pane illustrated in FIG. 10A.

Further below that, “combined form 1” and “Face 2” are set to a form file switching instruction 1206 and a face switching instruction 1207, respectively, so that a data block 1205 is inserted into a table B defined in the form file of “Face 2” of “combined form 1”. The table B corresponds to the table indicated in the right pane illustrated in FIG. 10B. The combined form file 1001 and the field data 406 inserted therein are overlaid in this manner, by which the form is generated.

A first exemplary embodiment will be described as processing for updating a display of the form according to a changed value by the web browser.

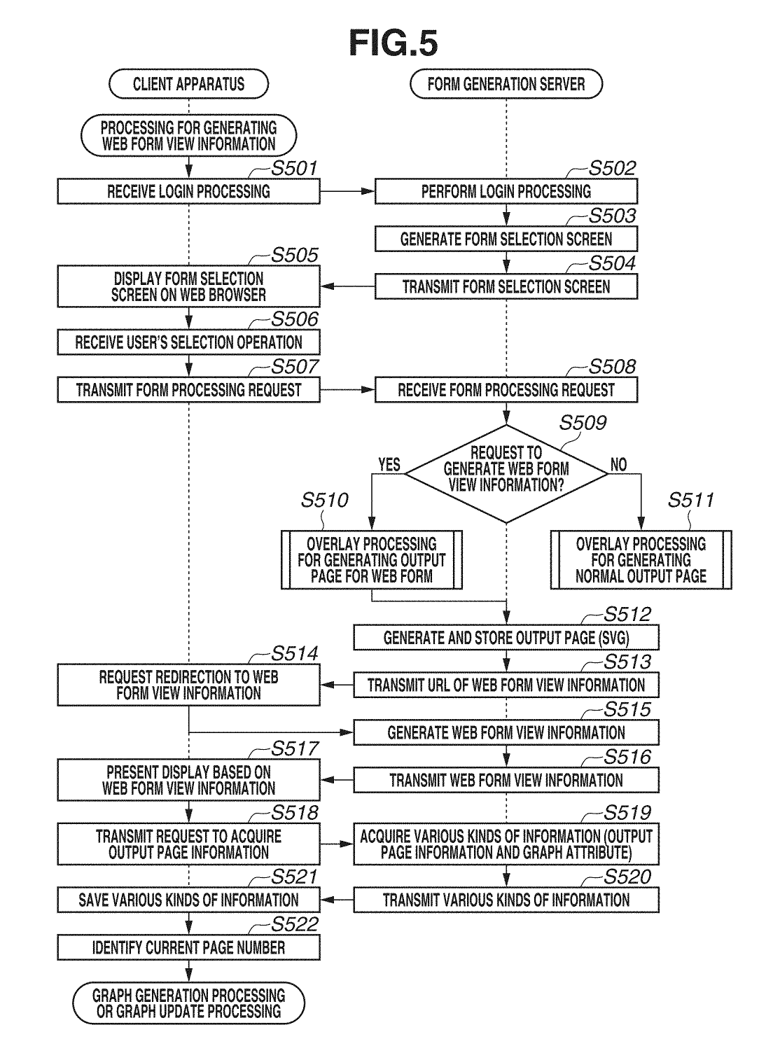

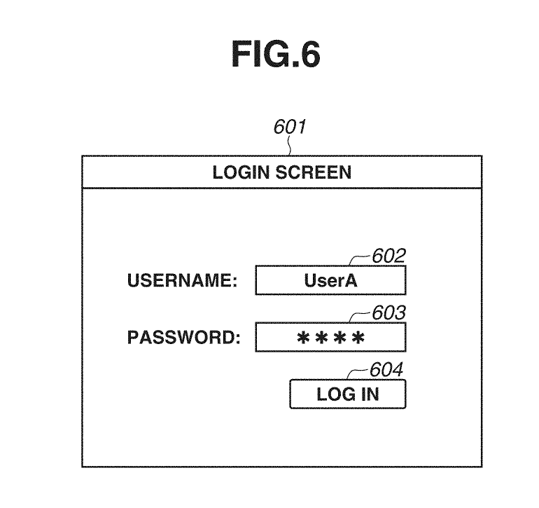

First, processing for generating the web form view information will be described with reference to FIG. 5. FIG. 5 is a sequence diagram for generating the web form view information. First, in step S501, the web browser of the client apparatus 102 receives an operation for a login to the form generation server 101 according to an operation of the user. FIG. 6 illustrates one example of a login screen at this time. The user transmits a request for the login to the form generation server 101 by inputting a username and a password to a username input text box 602 and a password input text box 603 on a login screen 601 and pressing a login button 604.

In step S502, the access control unit 301 of the form generation server 101 performs login processing according to a content of the login request received from the client apparatus 102. The access control unit 301 carries out the Basic authentication. If the username and the password are determined to be valid, the processing proceeds to a process of step S503. If the username and the password are determined not to be valid, an error is returned to the client apparatus 102 by a not-illustrated process.

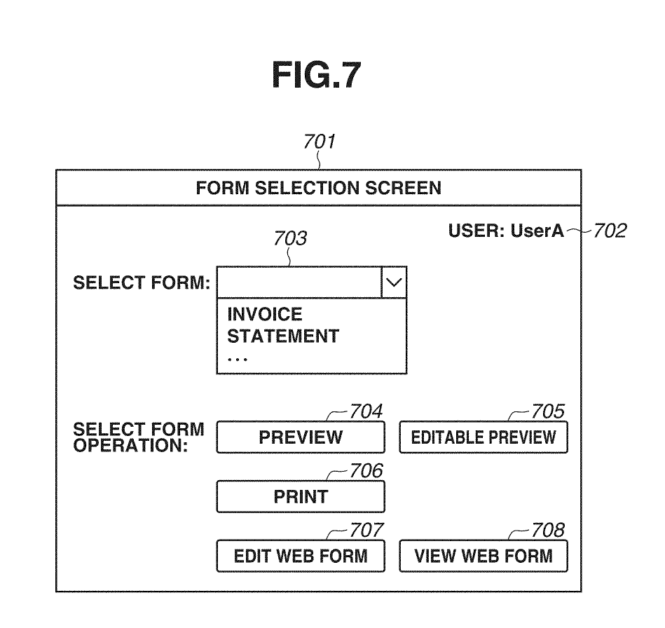

In step S503, the web page generation unit 302 of the form generation server 101 generates a form selection screen according to information of the user logged in to the form generation server 101. FIG. 7 illustrates one example of a form selection screen 701. A region 702 displays the username of the user currently logged in to the form generation server 101. A drop-down list 703 displays a list of forms currently owned by the login user. A content displayed in the drop-down list 703 is a form name of a form owned by the login user that the web page generation unit 302 extracts from the form-related data in the form-related data storage unit 305 via the data access unit 303.

Buttons 704 to 708 are form operation buttons. More specifically, the button 704, the button 705, the button 706, the button 707, and the button 708 allow the form selected in the drop-down list 703 to be previewed, previewed in an editable manner, printed, subjected to web form editing, and subjected to a web form view, respectively. In the following description, the sequence illustrated in FIG. 5 will be described focusing on processing when the button 708 is pressed, and omitting a description of processing after a button other than the button 708 is pressed.

In step S504, the access control unit 301 of the form generation server 101 transmits the form selection screen 701 generated in step S503 to the client apparatus 102 via the network 100. In step S505, the client apparatus 102 receives the form selection screen 701, which is a response from the form generation server 101, and displays the form selection screen 701 on the web browser.

In step S506, the user selects the form name from the drop-down list 703 on the form selection screen 701, and the client apparatus 102 receives this selection operation performed by the user. In step S507, the user transmits a form processing request to the form generation server 101 by pressing the button 708 on the form selection screen 701. At this time, information usable to identify the form targeted for the processing is also transmitted.

In step S508, the access control unit 301 of the form generation server 101 receives the form processing request from the client apparatus 102. Then, the output page generation unit 304 of the form generation server 101 acquires the form file and the field data file related to the form targeted for the processing via the data access unit 303.

In step S509, the access control unit 301 of the form generation server 101 determines whether the form processing request received in step S508 is a request to generate the web form view information. More specifically, the access control unit 301 analyzes a type parameter of the received request, and determines that this request is the request to generate the web form view information if a value of the type parameter is “webview”. The type parameter of the request is different from the above-described “type” indicating the graph type, and is one kind of parameter set inside a GET request in Hyper Text Transfer Protocol (HTTP) communication.

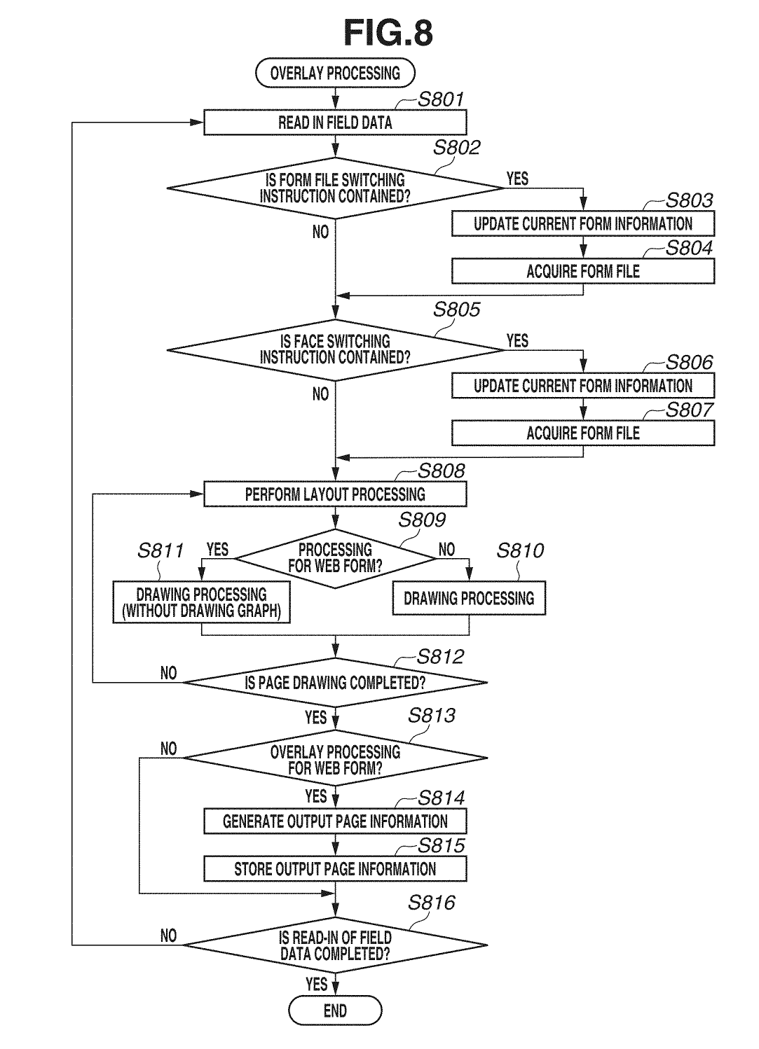

If the received request is determined to be the request to generate the web form view information in step S509 (YES in step S509), in step S510, the output page generation unit 304 of the form generation server 101 performs the overlay processing for generating the output page for the web form. At this time, the output page generation unit 304 uses the form file and the field data file acquired in step S508. On the other hand, if the received request is determined not to be the request to generate the web form view information in step S509 (NO in step S509), in step S511, the output page generation unit 304 of the form generation server 101 performs overlay processing for generating a normal output page. A description of processing after step S511 will be omitted herein because this processing is a commonly practiced flow. Further, details of steps S510 and S511 will be described below with reference to FIG. 8.

In step S512, the output page generation unit 304 converts the output page in the PDF format that has been generated in step S510 or S511 into an output page in the SVG format. The output page is converted from the PDF format into the SVG format for the following reason. First, the output page in the PDF format does not hold each drawing element such as a character string and a rectangle as an individual object independently, and is realized by a set of more basic commands to draw a line and a plane. For example, in the case of the rectangle, the rectangle is constituted by a command to move from an origin and a command to draw a line segment, and an object as the rectangle cannot be recognized in the PDF format. Therefore, maintaining the PDF format makes it difficult for the web browser to edit each drawing element. To solve this inconvenience, in step S512, the output page generation unit 304 converts the output page into the output page in the more easily editable SVG format that holds each drawing element independently. After the output page is converted into the SVG format, the output page generation unit 304 stores the generated output page in the SVG format into the output page storage unit 308 via the data access unit 303. Then, the output page generation unit 304 adds information usable to identify the output page in the SVG format (for example, the form name) to the record in the form-related data storage unit 305 storing the form-related data therein.

In step S513, the form generation server 101 transmits a Uniform Resource Locator (URL) of the web form view information to the client apparatus 102. The transmitted URL contains the information usable to identify the output page in the SVG format that has been generated in step S512. In the present example, assume that the URL contains the form name of the form-related data related to the output page.

In step S514, the client apparatus 102 transmits a request to redirect to the web form view information to the form generation server 101 using the URL received in step S513. In step S515, the web page generation unit 302 of the form generation server 101 generates the web form view information based on a content of the redirected request in step S514. The generated web form view information contains the output page in the SVG format, a JavaScript program for controlling an operation of viewing or editing the output page, and an HTML that forms the screen. The web page generation unit 302 acquires the output page related to the form targeted by the request from the output page storage unit 308 via the data access unit 303 using the form name contained in the redirected request in step S514. In a case where the form targeted for the processing contains a plurality of output pages, the web page generation unit 302 acquires as many output pages as the plurality of pages. The client apparatus 102 manages the plurality of output pages and page numbers in association with each other using the JavaScript program.

In step S516, the form generation server 101 returns the web form view information generated in step S515 to the client apparatus 102. In step S517, the client apparatus 102 receives the response from the form generation server 101 and presents a screen display on the web browser based on the web form view information. In the case where the form contains the plurality of output pages, the client apparatus 102 displays the first page first. In step S517, the client apparatus 102 draws an icon indicating that the web form view information is being loaded on the web browser until acquisition of information required in performing subsequent steps, step S518 and on is complete.

In step S518, the client apparatus 102 transmits a request to acquire the output page information to the form generation server 101. Asynchronous JavaScript+Extensible Markup Language (XML) (Ajax) is executed using the JavaScript program forming the screen, and the acquisition request is issued to a Representational State Transfer (REST) interface published by the form generation server 101. The client apparatus 102 transmits a request to acquire various kinds of information to the REST interface of the form generation server 101 by specifying the form name.

In step S519, the form generation server 101 acquires the various kinds of information related to the form targeted by the request via the data access unit 303 based on the form name contained in the received acquisition request. More specifically, the form generation server 101 acquires the output page information from the output page information storage unit 309, and the graph attribute from the form storage unit 306. The graph attribute is an attribute that the form generation server 101 stores into the form storage unit 306 in association with the form name in step S815, which will be described below.

In step S520, the form generation server 101 transmits the various kinds of information acquired in step S519 to the client apparatus 102 as a response. In step S521, the client apparatus 102 stores the acquired output page information and graph attribute into the RAM 203 in a state associated with the form name. This storage allows the JavaScript program on the client apparatus 102 to access the output page information and the graph attribute associated with the specific form with the form name serving as the key.

In step S522, the JavaScript program on the client apparatus 102 identifies the number of the currently displayed page. Normally, the first page is displayed when the output page is displayed for the first time. When the page transitions by an operation of the user while the screen is being loaded, the JavaScript program detects this transition and updates information indicating the number of the currently displayed page that is saved in the RAM 203.

The JavaScript program on the client apparatus 102 performs graph generation processing or graph update processing. The graph generation processing and the graph update processing are controlled by the JavaScript program distributed from the form generation server 101 in the present step. The JavaScript program, for example, operates the HTML loaded, together with a browser process, into the RAM 203 of the client apparatus 102 and read in onto the web browser, and issues a request to the server.

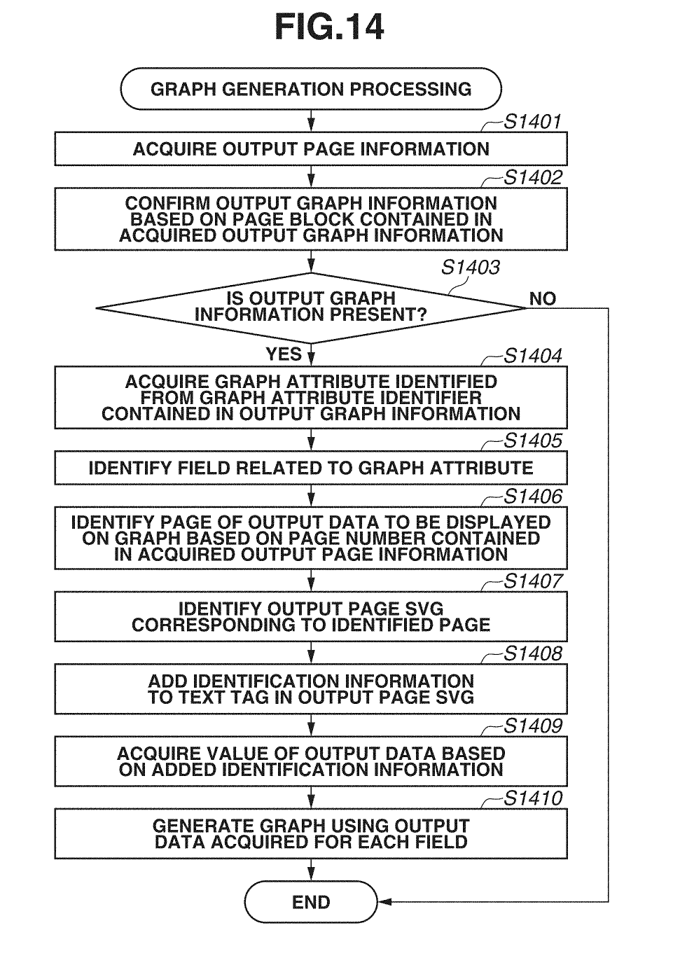

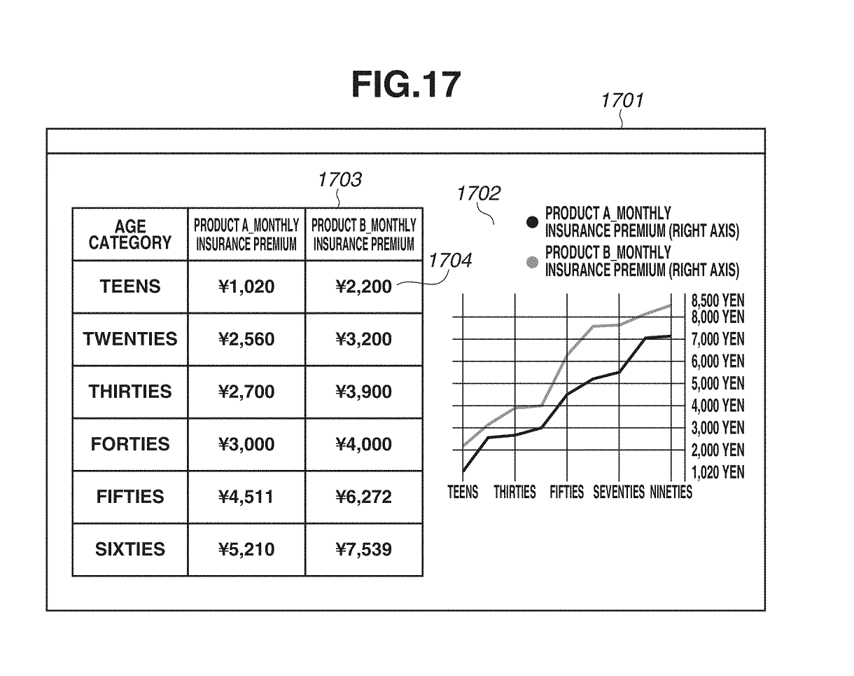

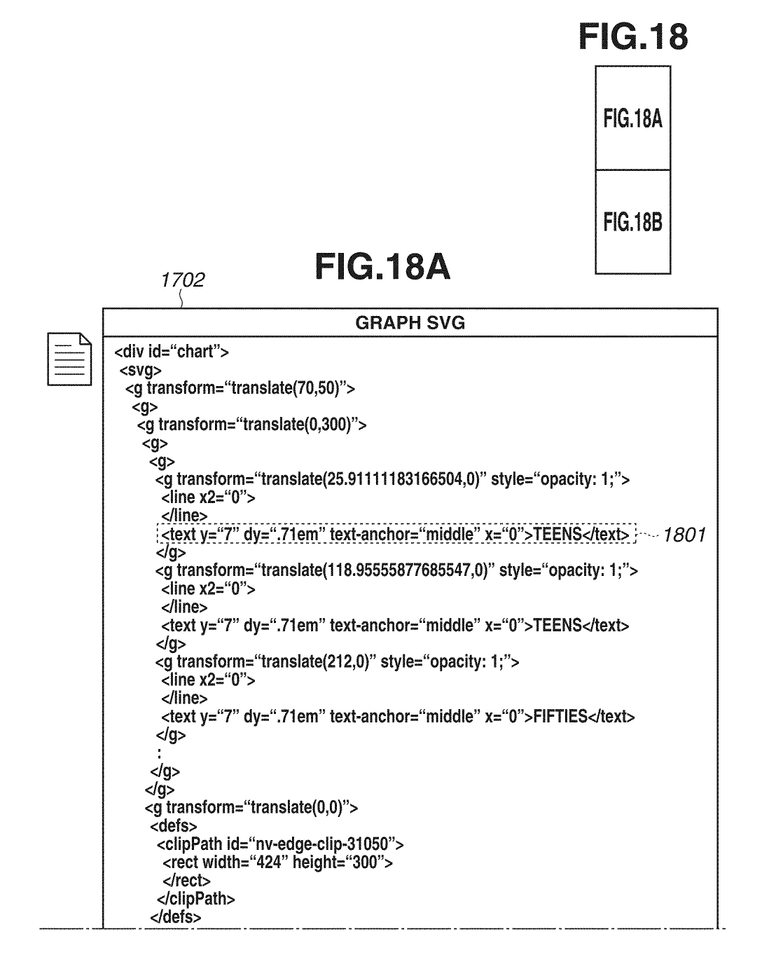

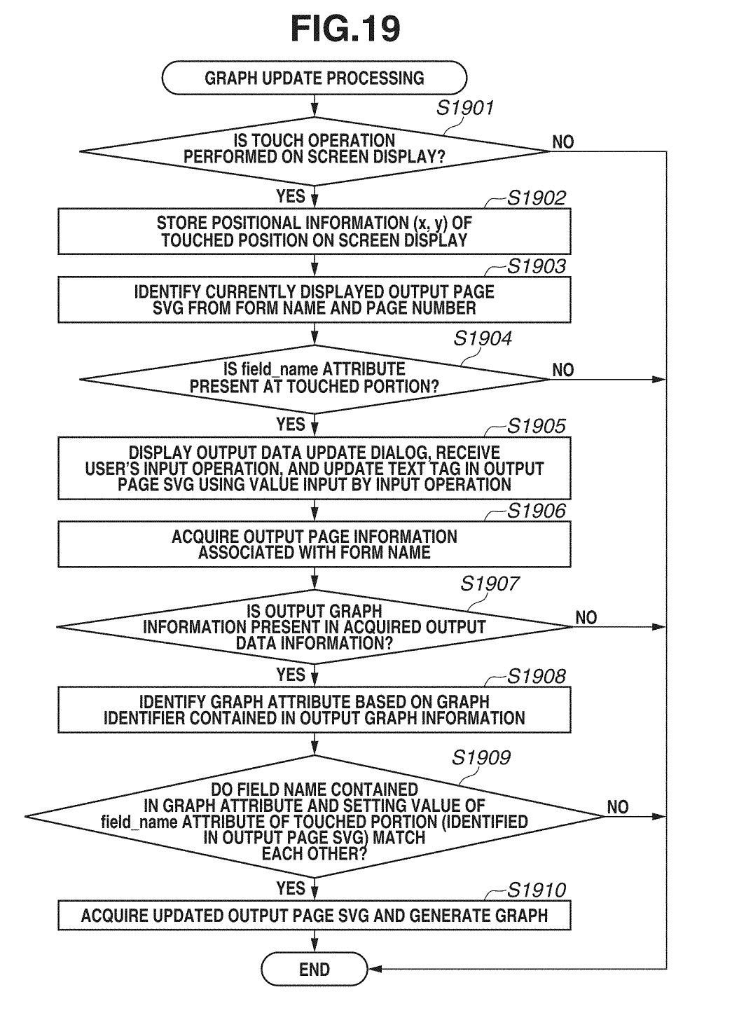

The graph generation processing will be described below with reference to FIG. 14, and the graph update processing will be described below with reference to FIG. 19. This is the processing for generating the web form view information. FIG. 17 illustrates one example of a screen display 1701 generated by the processing illustrated in FIG. 5. A graph 1702 in the SVG format that is generated in the sequence illustrated in FIG. 5 is displayed. Output data 1704 of a table 1703 is plotted as a polygonal line graph on the graph 1702.

Next, the overlay processing in steps S510 and S511 will be described with reference to FIG. 8. FIG. 8 is a flowchart illustrating an operation of the overlay processing using the form file and the field data by the form generation server 101. Steps S510 and S511 are basically similar processes, and therefore both the processes will be described with reference to FIG. 8 referring to a difference therebetween.

In step S801, the form generation server 101 reads in the field data targeted for the processing. One example of the field data is as illustrated in FIG. 12. In step S802, the form generation server 101 determines whether the form file switching instruction 1202 is contained in the read field data. If the form file switching instruction 1202 is determined not to be contained (NO in step S802), the processing proceeds to step S805. If the form file switching instruction 1202 is determined to be contained (YES in step S802), the processing proceeds to step S803.

In step S803, the form generation server 101 updates current form file information based on the form file switching instruction 1202 in step S802. The current form file information refers to information stored in a buffer area for keeping track of the form file currently targeted for the processing, and is managed in the RAM 203 of the form generation server 101. The form generation server 101 manages the form file that is a switching destination specified by the form file switching instruction 1202 as the current form file information.

In step S804, the form generation server 101 reads in the form file that is the switching destination set in the area in the RAM 203 that has been secured as the current form file information in step S803, into the RAM 203. In step S805, the form generation server 101 determines whether the face switching instruction 1203 is contained in the read field data. If the face switching instruction 1203 is determined not to be contained (NO in step S805), the processing proceeds to step S808. If the face switching instruction 1203 is determined to be contained (YES in step S805), the processing proceeds to step S806.

In step S806, the form generation server 101 updates current face information. The form generation server 101 manages the face that is a switching destination specified by the face switching instruction 1203 as the current face information. Even when the form file is not the combined form file but is a normal form file, the form generation server 101 processes the current face information in step S806 assuming that there is a virtual face. In step S807, the form generation server 101 reads in the form file that is the switching destination set as the current face in step S806 into the RAM 203.

In step S808, the form generation server 101 performs layout processing. The layout processing refers to processing that inserts the read field data into the field and determines a layout of various kinds of related objects such as a character string and a frame line of a rectangle based on various kinds of attributes such as a character size set to the field object associated with the field.

In step S809, the form generation server 101 determines whether this layout processing is processing for the web form. The process of step S809 is performed because different overlay processing should be performed between the output page that forms the web form view information and the output page used for a purpose other than that. The determination in step S809 is made based on a result of the determination in step S509. In other words, if the overlay processing in step S510 is performed, the processing proceeds to step S811. If the overlay processing in step S511 is performed, the processing proceeds to step S810.

If the present layout processing is determined not to be the layout processing for the web form in step S809 (NO in step S809), in step S810, the form generation server 101 performs drawing processing page by page. The form generation server 101 actually draws the various kinds of objects such as a character string according to a result of the layout processing performed in step S808. More specifically, the form generation server 101 draws the various kinds of objects using a function such as TextOut provided by Graphics Device Interface (GDI) of Windows.

If the present layout processing is determined to be the layout processing for the web form in step S809 (YES in step S809), in step S811, the form generation server 101 performs drawing processing page by page. Step S811 is basically a similar process to step S810, except for omitting the drawing of the graph 1007 in the form file.

In step S812, the form generation server 101 determines whether the drawing for one page is completed. The form generation server 101 does not perform each of the processes of steps S808 to S811 by recognizing a page break of each page. The form generation server 101 determines whether the drawing for one page is completed by detecting an overflow of the field data. More specifically, the form generation server 101 determines that the drawing for one page is completed upon detecting a read-in of the field data exceeding a maximum number of rows in the table defined in the form file, when repeating the layout and the drawing while inserting the field data into the table.

If the drawing for one page is not completed (NO in step S812), the processing returns to step S808, from which the layout processing continues. If the drawing for one page is determined to be completed (YES in step S812), the processing proceeds to step S813.

In step S813, the form generation server 101 determines whether this overlay processing is the overlay processing for the web form. A process content thereof is similar to step S809, and this determination is made based on the result of the determination in step S509. If the present overlay processing is determined not to be the overlay processing for the web form in step S813 (NO in step S813), the processing proceeds to step S816.

If the present overlay processing is determined to be the overlay processing for the web form in step S813 (YES in step S813), in step S814, the form generation server 101 generates the output page information. More specifically, in step S814, the form generation server 101 additionally writes information of page blocks 912 and 913, which will be described below, into the output page information based on the names of the currently processed form file and face and the current number of output pages. Further, the form generation server 101 additionally writes the information regarding each piece of output data that has been calculated in the layout processing in step S808 into an output data information block 906, which will be described below. More specifically, the form generation server 101 additionally writes a “field name”, an “output data identifier”, and “position and size information” for each piece of output data. Because a plurality of pieces of output data may be associated with the same field in one page, the “output data identifier”, which will be described below, is generated so as to be unique for each piece of output data. Further, if the graph has been output onto the current output page as a result of the layout processing in step S808, the form generation server 101 additionally writes output graph information 907 into the page block 912 in output page information 901. An attribute identifier of the output graph is identified from the graph attribute 1101 in the form file, and is additionally written as a graph attribute identifier 908. Further, the form generation server 101 identifies a related field (“product A_monthly insurance premium”, “product B_monthly insurance premium”, and “age category” in the present exemplary embodiment) from the graph attribute 1101 in the form file, and additionally writes the number of the page onto which the output data associated with this field has been output into an output graph data range 910, which will be described below.

In step S815, the form generation server 101 stores the generated output page information into the output page information storage unit 309 storing the output page therein via the data access unit 303. Then, the form generation server 101 stores information for identifying this output page information into the form-related data storage unit 305 storing the form-related data therein.

In step S816, the form generation server 101 determines whether the read-in of the field data is completed. If the read-in is completed (YES in step S816), the overlay processing is ended. If the read-in is not completed (NO in step S816), the processing returns to step S801, in which the form generation server 101 reads in the field data and continues the overlay processing. This is the overlay processing in steps S510 and S511.

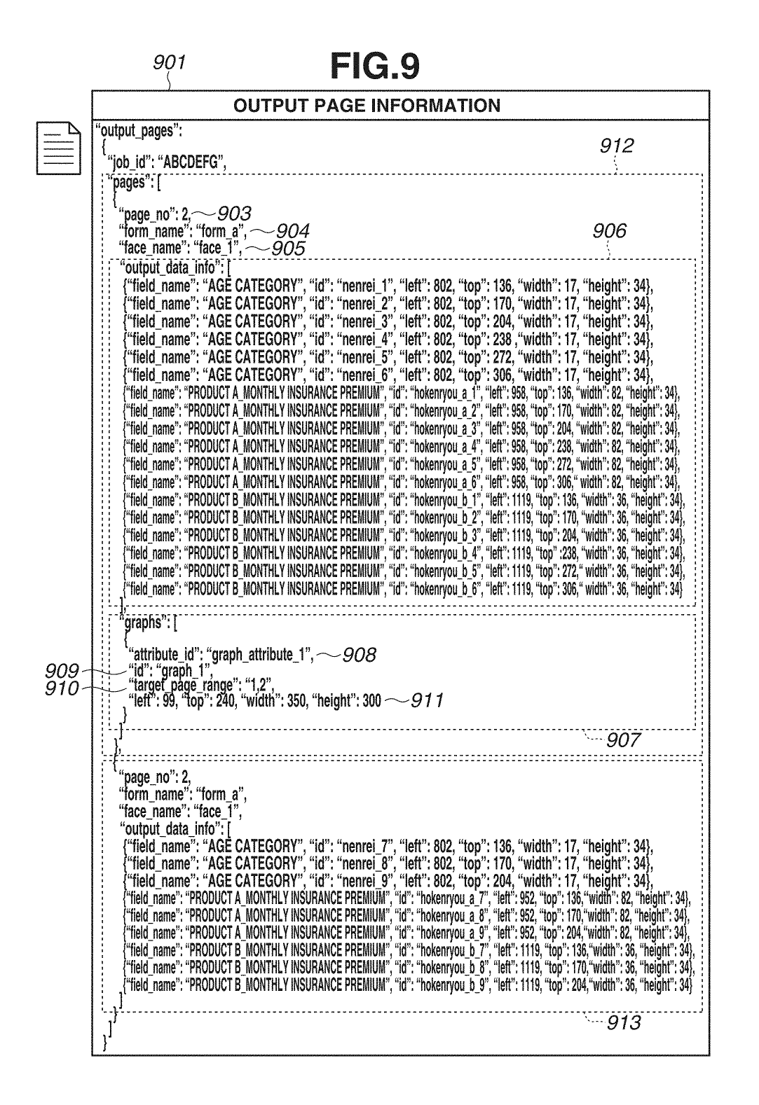

The output page information generated in step S814 will be described with reference to FIG. 9. FIG. 9 illustrates one example of the output page information. The output page information is information used when the web form view information is generated or when the graph is drawn, and contains the information additionally written by the overlay processing illustrated in FIG. 8. In the present example, the output page information will be described assuming that the file format thereof is the JSON format, but is not limited to this file format.

The output page information 901 includes the plurality of page blocks 912 and 913. The page block 912 and the page block 913 are blocks in which pieces of information regarding the output page for each page are put together. For example, the page block 912, which is the first block in the output page information 901, has a page number 903, a used form file name 904, and a used face name 905. The used form file name 904 is the name of the form file used in this output page. The used face name 905 is the name of the face used in this output page. In the present example, it can be seen that a form file “form_a” (a face “face 1”) is output onto the first page.

The output data information block 906 is information of the output data output onto each output page. The field data is inserted into each field, and is drawn on the output page according to a character color attribute and a font attribute of the associated field object. The output data is this drawn resultant element. The information of each piece of output data is enumerated in the output data information block 906. One element in the output data information block 906 includes the “field name” (field_name) associated with the output data, the “output data identifier” (id), and the “position and size information” (left, top, width, and height) specifying a position and a size at and in which the output data is drawn.

The output graph information 907 is the information regarding the graph output onto the output page. In the present example, the graph is present only on the page specified by the page block 912, and therefore it can be seen from FIG. 9 that, for example, no output graph information is contained in the second page block 913. The output graph information 907 has the graph attribute identifier 908 (attribute_id), an output graph identifier 909 (id), the output graph data range 910 (target_page_range), and an output graph position 911 (left, top, width, and height). The graph attribute identifier 908 corresponds to the graph attribute identifier 1102 for identifying the graph attribute 1101, and can be used to identify which graph attribute is followed to generate this graph. The output graph data range 910 is the page number of the output data used in this graph. In a case where the output data used in the graph spans a plurality of pages, page numbers are enumerated in a comma-delimited manner. In the present example, it can be seen from “1.2” written therein that the graph identified from the output graph information 907 is drawn using the output data of the first page and the second page. This is the description regarding the output data information.

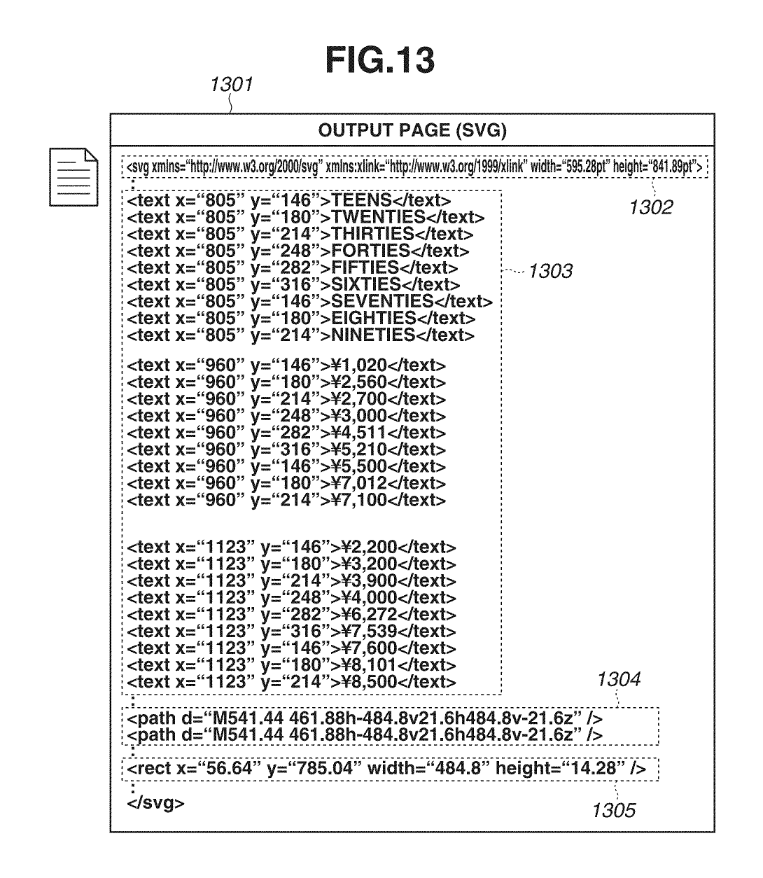

The output page converted into the SVG format will be described with reference to FIG. 13. FIG. 13 illustrates one example of the output page converted into the SVG format. As described above, in step S512, the output page is converted into the SVG format when the web form view information is generated. In an output page SVG 1301, each drawing element is expressed in a tag format as an independent object. In an SVG tag 1302, various drawing elements of the entire output page are contained in a mixed manner. A text tag 1303 is a character string element, in which an actual drawing character string is enclosed by <text>tags and drawing coordinates thereof are specified by a tag attribute (x and y). For example, “<text x=“805” y=“146” >TEENS</text>” means that “TEENS” is drawn at a portion identified from the drawing coordinates (805, 146). Besides the text tag 1303, a ruled line and a rectangle are also drawn according to a ruled line tag 1304 and a rectangle tag 1305. This is the description regarding the output page in the SVG format.

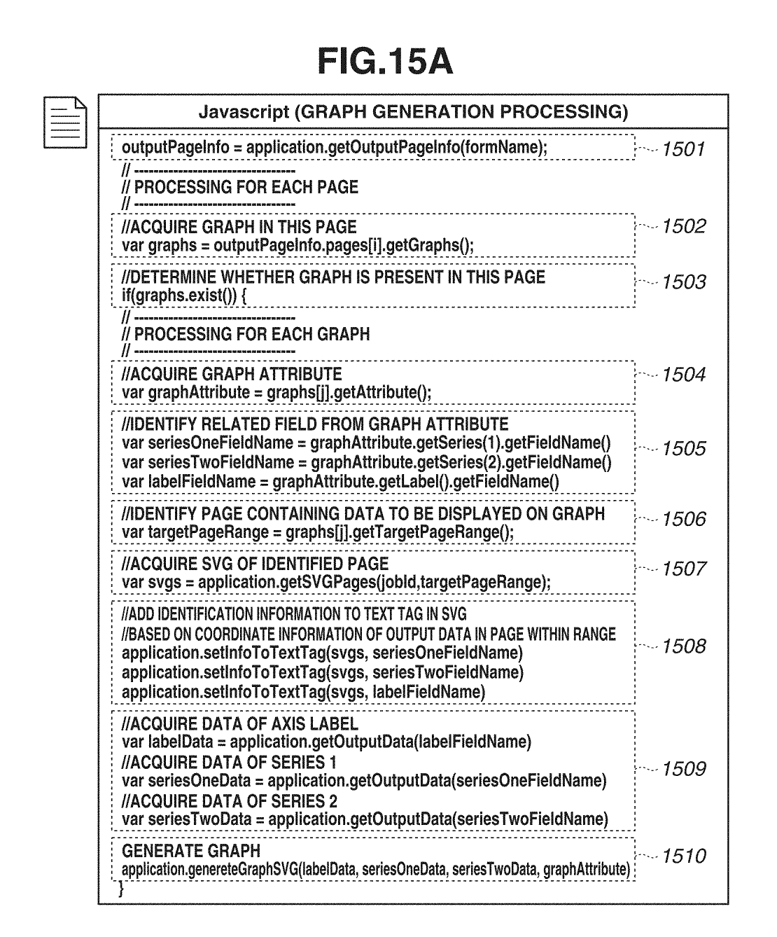

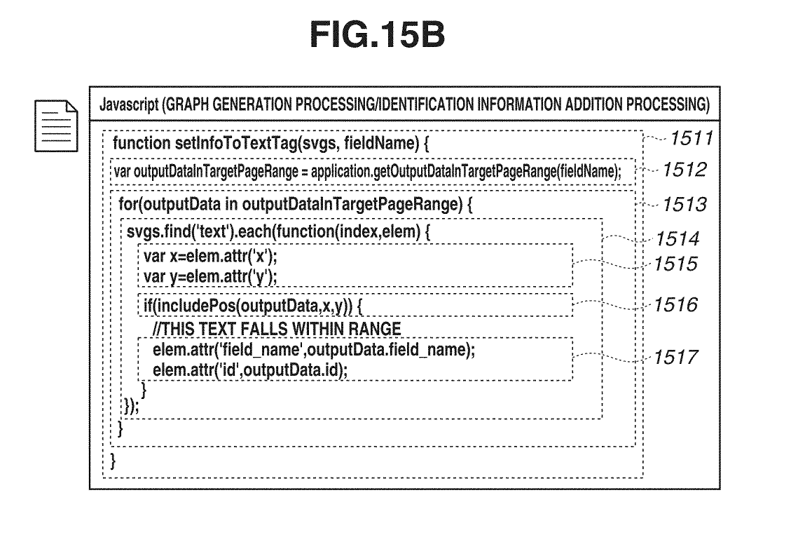

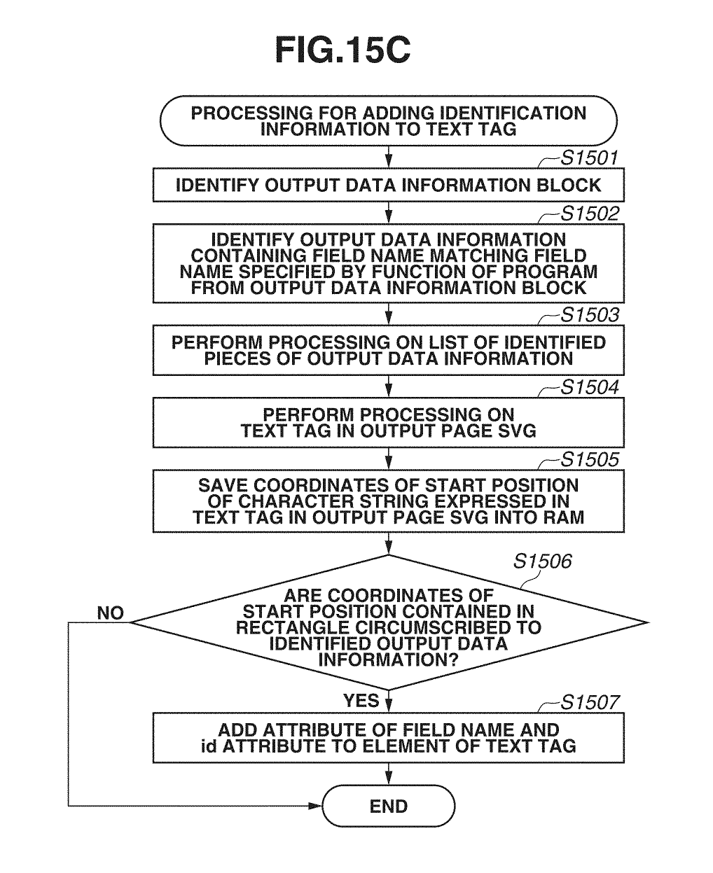

Next, the graph generation processing performed by the JavaScript program on the client apparatus 102 when the web form view information is generated will be described with reference to FIGS. 14 and 15A. FIG. 14 is a flowchart of the graph generation processing, and FIG. 15A illustrates one example of the JavaScript program for performing the graph generation processing. In the following description, for convenience of the description, the graph generation processing will be described assuming that the JavaScript program (hereinafter referred to as the program) or each program forming it (1501 to 1510) performs the graph generation processing. In reality, the CPU 201 actually performs the graph generation processing, as the program such as the OS or the application stored in the ROM 202 or the like of the client apparatus 102 is loaded into the RAM 203, and the CPU 201 sequentially reads out commands of this program to execute them.

In step S1401, the program 1501 acquires the output page information 901 stored in the RAM 203 in association with the form name. In step S1402, the program 1502 acquires the graph present in the currently displayed output page. More specifically, the program 1502 checks the page block 912 and the output graph information 907 written in the output page information 901 acquired in step S1401.

In step S1403, the program 1503 determines whether the currently displayed output page contains one or more graph(s). More specifically, the program 1503 checks whether the output graph information is contained in the output page information 901 acquired in step S1401. If the output graph information is contained (YES in step S1403), an exist method returns a return value “true”, and the graph is determined to be present. If the output graph information is determined not to be contained (NO in step S1403), the graph generation processing is ended.

After the output graph information is determined to be contained (YES in step S1403), in step S1404, the program 1504 acquires the graph attribute 1101. More specifically, the program 1504 acquires the graph attribute identified from the graph attribute identifier 908 of the output graph information 907 from among a plurality of graph attributes stored in the RAM 203. Since a plurality of graphs can be defined in the form file, a plurality of graph attributes may be stored in the RAM 203. In the present example, assume that the graph attribute identified from the graph attribute identifier 908 is the graph attribute 1101 (FIG. 11).

In step S1405, the program 1505 identifies the related field based on the acquired graph attribute 1101. More specifically, the program 1505 identifies the field by checking the field name defined in the field name 1 105 and the label field name 1107 written in the graph attribute 1101 acquired in step S1404.

In step S1406, the program 1506 identifies the page containing the output data to be displayed on the graph. More specifically, the program 1506 identifies the page containing the output data required to display the graph by acquiring the value of the page number (910) written in the output graph data range 910 in the output page information 901 acquired in step S1401. In the present example, the output pages of the first page and the second page are identified from the output graph data range 910.

In step S1407, the program 1507 identifies the output page SVG 1301 of the page identified in step S1406 that has been converted into the SVG format in step S512. More specifically, the program 1507 acquires the output page SVG 1301 stored in the RAM 203. In step S1408, the program 1508 assigns identification information to the text tag 1303 in the acquired output page SVG 1301.

Before the process of step S1408 is performed, presence/absence of a character string can be determined by checking the text tag 1303 in the output page SVG 1301. However, this check does not make it possible to determine whether this character string is the output data generated from the field object and related to the field. The process of step S1408 is a process for making it easy to determine whether the character string in the output page SVG 1301 is the output data related to the field. Processing for assigning the identification information to the text tag 1303 will be described below with reference to FIG. 15B.

The identification information is assigned based on the coordinate information of the output data in step S1408, but the identification of the text tag 1303 is not limited to this method. The identification of the text tag 1303 may be carried out in any manner as long as the program can determine which field the character string is associated with, and this determination may be made in real time based on the coordinate information when the output page SVG 1301 is scanned. The program 1508 scans the output page SVG 1301, and assigns the identification information to the text tag 1303 determined to be the output data related to the field name 1105 or the label field name 1107 acquired in step S1405.

In step S1409, the program 1509 identifies the text tag 1303 based on the identification information assigned in step S1408, and acquires the value of the output data. More specifically, the program 1509 detects all of text tags 1303 having a target field name (for example, “age category”, which is a value of a labelFieldName variable) as the field_name attribute thereof. The search for the text tag 1303 is carried out by calling an application programming interface (API) for operating the HTML loaded on the web browser and each SVG tag element. Such an API for operating the text tag element is standardized by an international standardization organization or the like, and is implemented on each web browser as a standard function.

The program 1509 acquires the value of each tag (for example, “teens” or “\1,020”) and the value of id (the output data identifier), and saves them into the RAM 203 in a manner associated with the field name. The program 1509 performs the processing for acquiring the value of the output data (S1409) with respect to the three field names. For example, the program 1509 acquires the output data associated with the “age category” field from the text tag 1303 in the output page as data of the X-axis label. The program 1509 acquires the output data associated with the “product A_monthly insurance premium” field from the text tag 1303 in the output page as data of a series 1. The program 1509 acquires the output data associated with the “product B_monthly insurance premium” field from the text tag 1303 in the output page as data of a series 2.

In step S1410, the program 1510 generates the graph using the three groups of pieces of output data (related to the three fields) acquired by the program 1509. At this time, the program 1510 also uses the graph attribute 1101 for determining the type of the graph (a bar graph, a line graph, or the like) besides the actual data. The graph attribute 1101 is read in the RAM 203. In the present exemplary embodiment, the program 1510 is assumed to also output the graph generated in step S1410 in the SVG format, but may output the graph in another file format as long as the graph can be displayed on the web browser and can be easily operated from the program.

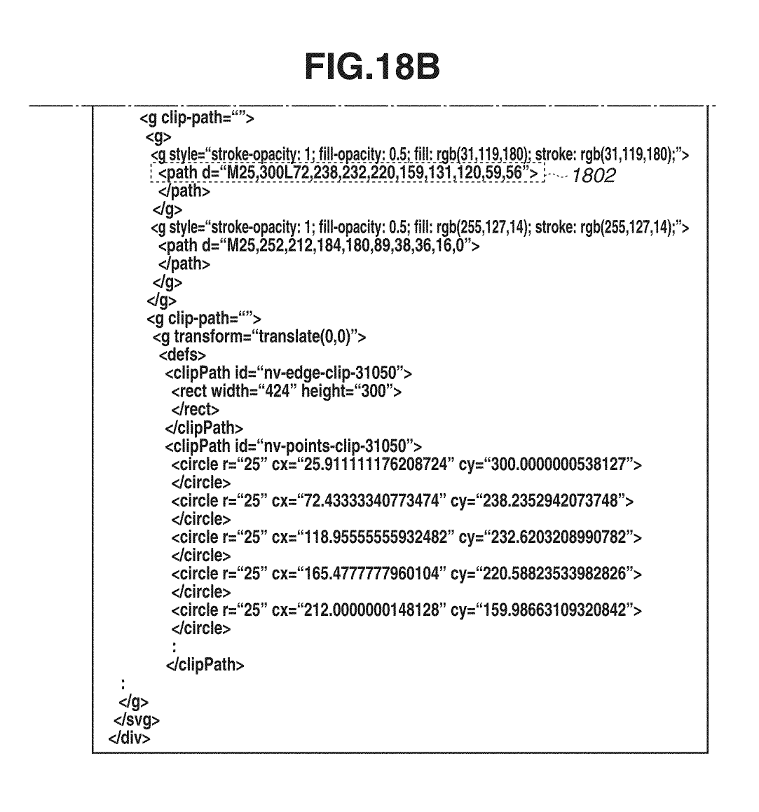

Further, in the present exemplary embodiment, the JavaScript program performs control so as to generate the graph in the SVG format (S1410) in addition to the output page SVG 1301 and display them by superimposing them on the web browser, but may be configured to add a graph SVG as an element to the output page SVG 1301. Each element of the graph is sequentially drawn based on the value of the output data and the graph attribute 1101, but it is not common to directly output each SVG tag element from the program. It is common to use, for example, a JavaScript library specially prepared to visualize the data for the generation of the graph. In the present exemplary embodiment, the library is also used and therefore the SVG element is not directly generated from the program. This is the description regarding the graph generation processing. FIG. 18 illustrates one example of the graph 1702 generated by the processing illustrated in FIG. 14. It can be seen that a value 1801 of the X-axis label, a polygonal line element 1802, and the like are written as independent tag elements, and are in a state operable from the program.

The processing for assigning the identification information to the text tag 1303 will be described with reference to FIGS. 15B and 15C. FIG. 15B (a program 1511) and a flow illustrated in FIG. 15C are executed by being called by the program 1508. As also described above, in step S1408, the program 1508 performs the processing for assigning the identification information to the text tag 1303 in the acquired output page SVG 1301.

First, in step S1501, a program 1512 identifies the output data information block 906 of each of all the pages identified in step S1406. The program 1512 identifies the output data information block 906 owned by each of the pages by checking the page number 903 matching the output page information 901 identified in step S1401.

In step S1502, the program 1512 scans each piece of output data in the output data information block 906, and identifies the output data information having the field name matching the field name (fieldName) specified by a function of the program 1512 from the output data information block 906. In the present example, the field name information (field_name) written in the output data information block 906 is identified. A list of the identified pieces of output data information is saved in the RAM 203 (a variable name: outputDatalnTargetPageRange).

In step S1503, a program 1513 performs processing on each of the pieces of output data in the list saved by the program 1512. In this processing, in step S1504, a program 1514 scans the text tag 1303 in the output page SVG 1301, and performs the processing on each text tag 1303. A variable elem written in the program 1514 indicates the text tag element. For example, an attribute can be added to the text tag element by calling a method of the variable elem. Processing for adding the attribute to the text tag element will be described below. In step S1505, a program 1515 saves coordinates (a variable x and a variable y) of a start position of the character string expressed by the text tag 1303 into the RAM 203.

In step S1506, a program 1516 determines whether the coordinates of the start position saved in the RAM 203 are contained in a rectangle circumscribed to the output data information acquired by the program 1512. More specifically, the size of the rectangle circumscribed to the output data is acquired from values of left, top, width, and height, which are the output data information in the output data information block 906. If the coordinates of the start position are determined not to be contained in step S1506 (NO in step S1506), the processing for assigning the identification information is ended.

If the coordinates of the start position are determined to be contained in step S1506 (YES in step S1506), in step S1507, a program 1517 adds two attributes to the text tag element by calling an attribute addition method (attr) of the variable elem. One of them is the field_name attribute, and the field name information (field_name) of the output data in the output data information block 906 is set as a value thereof. The other of the two attributes is the id attribute, and the ID information (id) of the output data in the output data information block 906 is set as a value thereof.

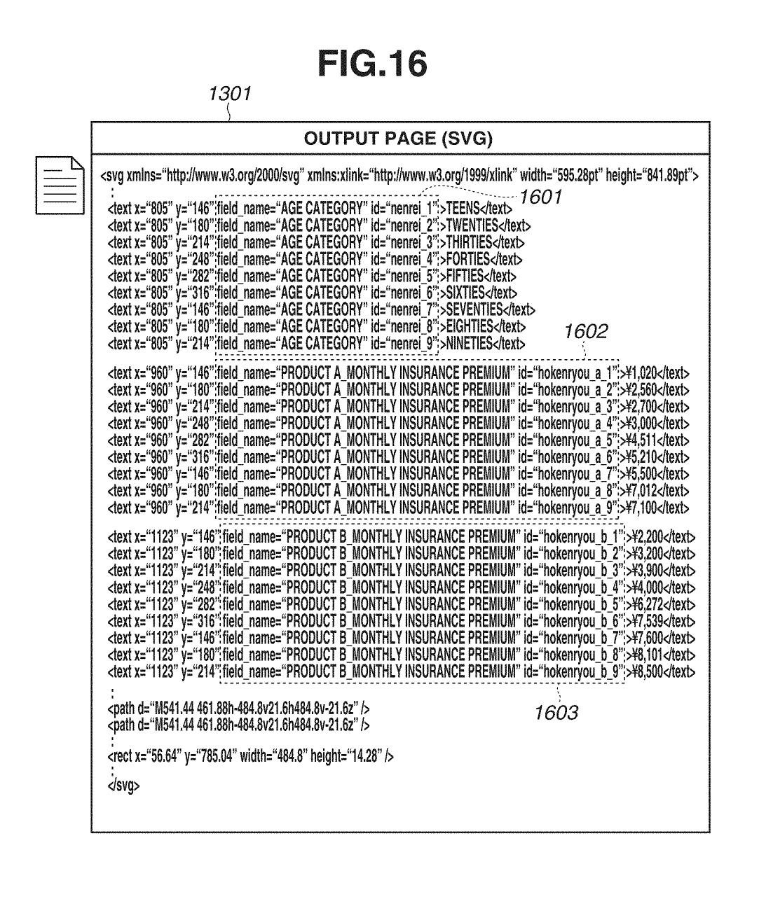

FIG. 16 illustrates one example of the output page SVG 1301 after the identification information is assigned by the program 1508 (or the processing illustrated in FIGS. 15B and 15C). The field name information (field_name) and the ID information (id) are assigned, as the identifier, to the text tag 1303 determined to be the output data associated with the field as indicated in 1601 to 1603. Unique ID information is assigned in 1601 to 1603 also in consideration of a possibility that the plurality of pieces of output data associated with the same field may be output onto one page. The ID information is generated by being incremented in the order that the output data is inserted by the overlay processing. This is the processing for assigning the identification information.

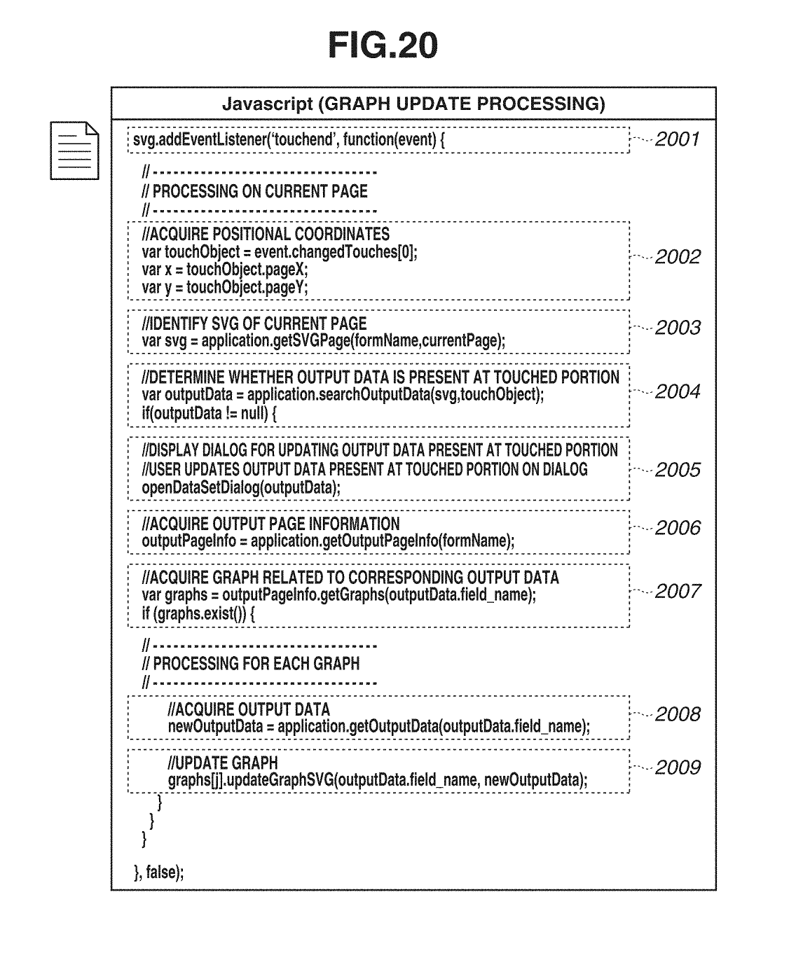

Next, the graph update processing illustrated in FIG. 5 will be described in detail with reference to FIGS. 19 and 20. FIG. 19 is a sequence diagram of the graph update processing performed by the JavaScript program on the client apparatus 102. FIG. 20 illustrates one example of the JavaScript program for performing the procedure illustrated in FIG. 19.

First, in step S1901, a program 2001 determines whether a touch operation is performed onto the screen display 1701 by the user. If the touch operation is determined not to be performed (NO in step S1901), the graph update processing is ended. If the touch operation is determined to be performed (YES in step S1901), the program 2001 is called by the web browser. Information regarding the touch operation set by the web browser is stored into a variable event.

In step S1902, a program 2002 stores element information of the touched portion on the screen display 1701 into a variable touchObject as the positional information (the variables x and y). In step S1903, a program 2003 identifies the output page SVG 1301 of the currently displayed screen display 1701 from the form name and the current page number. The output page SVG 1301 is stored in the RAM 203, and is brought into a state that a program 2008, which will be described below, can access the output page SVG 1301 in the RAM 203.

In step S1904, a program 2004 determines whether the output data is present at the touched portion. If the output data is determined not to be present (NO in step S1904), the graph update processing is ended. As a method for making the determination in step S1904, specifically, the presence/absence of the output data can also be determined based on the positional information (the variables x and y) of the portion subjected to the touch operation. However, in the present example, it is assumed to be determined using the element information subjected to the touch operation. More specifically, information regarding an SVG constituent element (for example, the text tag 1601) present at the touched coordinates is stored into the variable touchObject by the web browser. The program 2004 determines that the output data is present at the touched portion (YES in step S1904) if the text tag 1601 is stored in the variable touchObject and if this text tag 1601 further has the field name attribute. The field name attribute is the attribute assigned in step S1408.

After the output data is determined to be present in step S1904 (YES in step S1904), in step S1905, a program 2005 displays a not-illustrated output data update dialog to the user, and updates the output page SVG 1301 using a value input on the output data update dialog. In the case of the present example, the output page SVG 1301 is updated.

While the client apparatus 102 displays the output data update dialog, the graph update processing is interrupted, and is brought into a state waiting for an input operation from the user. The value of the output data identified in step S1904 is displayed in a text area of the displayed output data update dialog as a default value. The user inputs any value to the text area and presses an OK button, which triggers the execution of the processing for updating the value in this output page SVG 1301.

In step S1906, a program 2006 acquires the output page information 901 associated with the form name. In step S1907, a program 2007 determines whether there is the graph related to the output data information acquired in step S1906. More specifically, the program 2007 checks the output page information 901 acquired in step S1906, and determines whether the output graph information 907 is contained in the page block 912 or 913 of the current page. If the output graph information 907 is determined not to be contained (NO in step S1907), the graph update processing is ended.

If the output graph information 907 is determined to be contained in the acquired output data information in step S1907 (YES in step S1907), the processing proceeds to step S1908. If the output graph information 907 is determined not to be contained (NO in step S1907), the table 1703 is updated using the output page SVG 1301 updated in step S1905, and the graph update processing is ended.

If the output graph information 907 is determined to be contained in step S1907 (YES in step S1907), in step S1908, the program 2008 identifies the graph attribute 1101 based on the output graph identifier 909 contained in the output graph information 907.

In step S1909, the program 2007 determines whether the field name contained in the graph attribute 1101 and the setting value of the field_name attribute of the touched portion identified in the output page SVG 1301 match each other. If they are determined to match each other (YES in step S1909), the processing proceeds to a process of step S1910. If they are determined not to match each other (NO in step S1909), the graph update processing is ended.

As a process content of step S1909, specifically, the program 2007 determines whether the value of the field_name attribute in the output page information 901 matches the field name 1105 or the label field name 1107 used as the series data of the graph attribute 1101. In the case of the present example, the field name of the graph attribute 1101 is “product A_monthly insurance premium”, “product B_monthly insurance premium”, and “age category”, and the program 2007 determines whether the value of the field_name attribute in the output data information is any of them.

In step S1910, the program 2008 acquires the updated output page SVG 1301, and a program 2009 updates the graph 1702 using the output data SVG 1301 updated in step S1905.

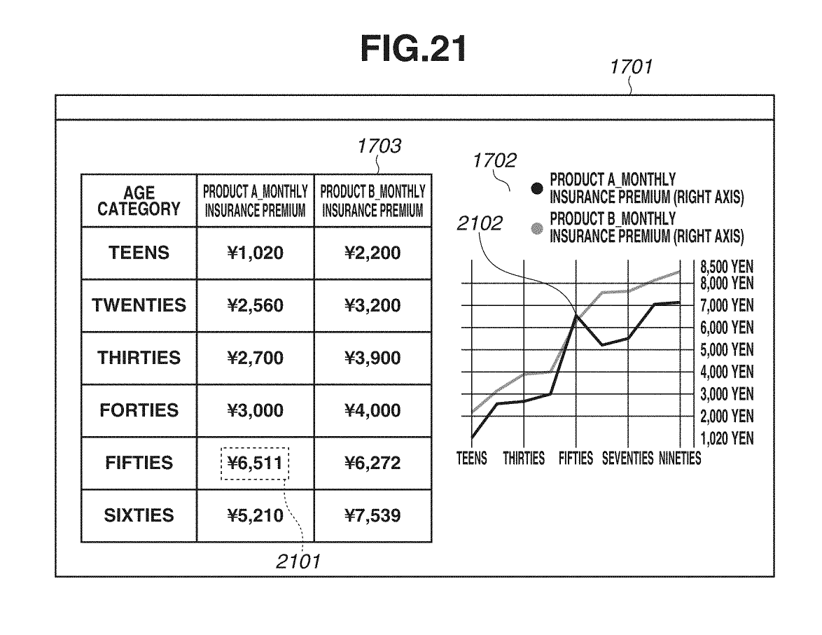

FIG. 21 illustrates one example of a screen display containing the graph 1702 updated by the graph update processing illustrated in FIGS. 19 and 20. FIG. 21 illustrates an example when output data 2101 in the table 1703 is changed by the user. Then, a corresponding plot 2102 in the polygonal line graph of the graph 1702 is also updated in conjunction with this output data value. This is the description regarding the graph update processing.

In the present exemplary embodiment, the graph in the vector format (SVG) is used to update only a part desired to be changed without regenerating the entire graph, and change the graph display according to the user operation. SVG has been formulated based on internationally standardized specifications called Document Object Mode (DOM), and allows each element to be easily operated from the JavaScript (registered trademark) program distributed and loaded onto the web browser of the client. As long as the required data is all acquired, the JavaScript program for operating the graph in the SVG format runs without communicating with the form generation server 101 after being distributed to the web browser. Due to this configuration, the form can be changed according to the user operation without requiring the client apparatus 102 and the form generation server 101 to communicate with each other.

A second exemplary embodiment will be described as processing in a case where the table object 1006 is not contained and only the graph 1007 is contained in the form file.

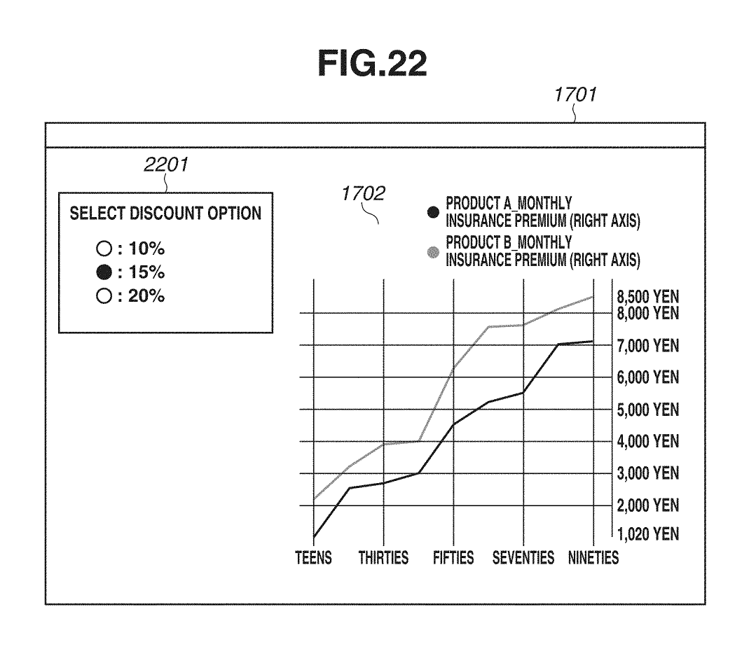

FIG. 22 illustrates one example of a screen display based on the web form view information according to the present exemplary embodiment. When the overlay processing is performed using the form file containing only the graph object, only the graph 1702 is present in the output page. When the output data as a result of inserting the field data into the table object (1704 illustrated in FIG. 17) is not present on the output page SVG according to the second exemplary embodiment, the value of the output data cannot be acquired from the text tag in the output page SVG unlike S1409 according to the first exemplary embodiment.

The present exemplary embodiment will be described focusing on processing for holding the output data in the present exemplary embodiment in which the output data is not present on the output page SVG. Processing for receiving a change made to the held output data and updating the display of the related graph is similar to the processing of step S1906 and the steps subsequent thereto illustrated in FIG. 19 (the first exemplary embodiment), and therefore a description thereof will be omitted here. Further, features and components that will not be described in the second exemplary embodiment are similar to those described in the first exemplary embodiment.

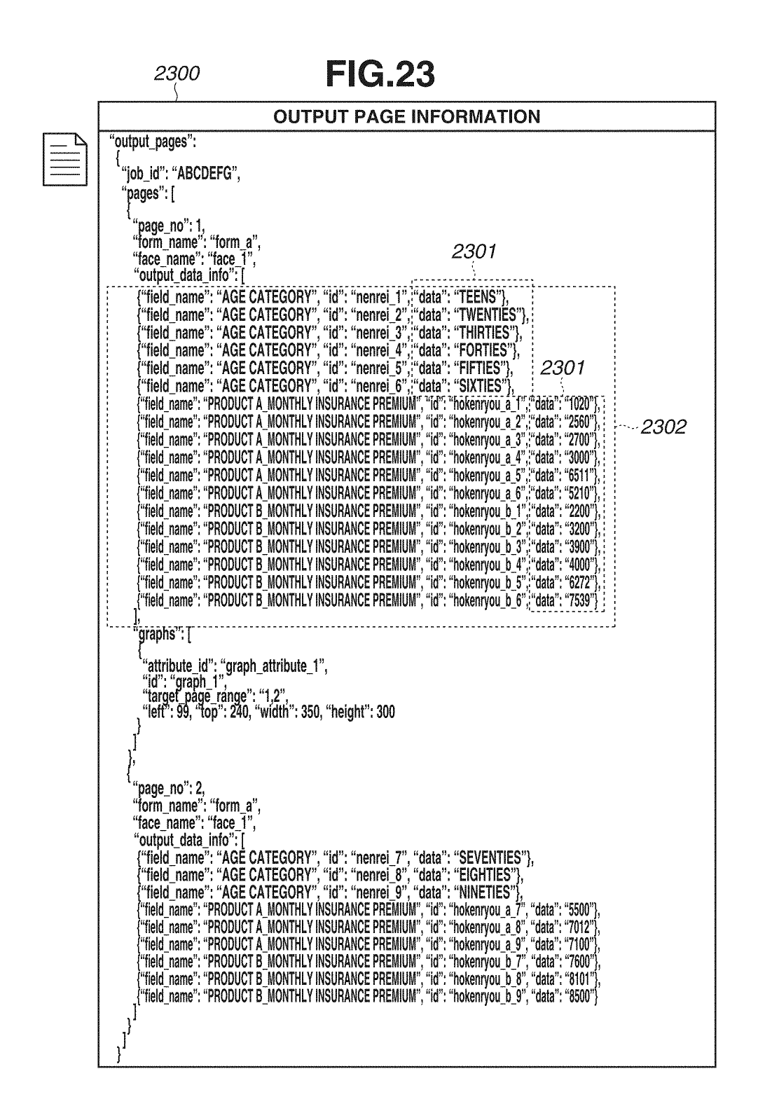

FIG. 23 illustrates one example of output page information 2300 according to the present exemplary embodiment. The present exemplary embodiment is different from the first exemplary embodiment in terms of the processing for generating the output page information in step S814. Differently from the process of step S814 according to the first exemplary embodiment, in the present exemplary embodiment, the form generation server 101 outputs the “field name” (field_name), the “output data identifier” (id), and “actual data” (data) 2301 into an output data information block 2302 in the output page information 2300. The form generation server 101 outputs the actual data 2301 assuming that the data used in the graph at the time of the overlay processing is the output data regarding the field related to the graph (the field in which the series data or the X-axis label is specified). The form generation server 101 does not actually perform the processing for drawing the output data and therefore does not output the “position and size information” (left, top, width, and height) into the output data information block 2302 like the output data information block 906 (the first exemplary embodiment).

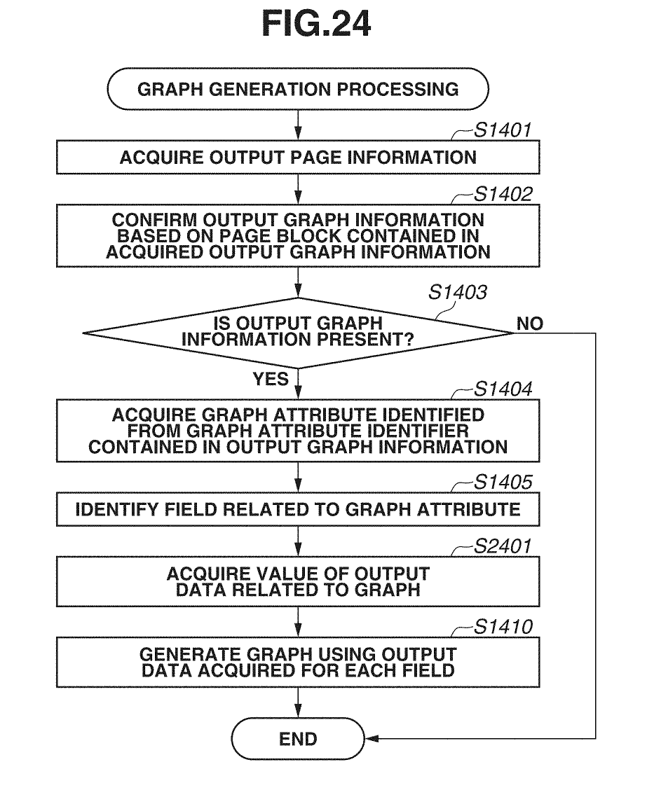

FIG. 24 is a sequence diagram of graph generation processing according to the present exemplary embodiment. Differently from the processing according to the first exemplary embodiment (FIG. 14), the value of the output data used in the graph is not present on the output page SVG but is present in the output page information 2300. In other words, the present exemplary embodiment does not require the processing for assigning the identification information to the text tag in the output page SVG and acquiring the value of the output data from the text tag identified based on the assigned identification information (steps S1406 to S1409 illustrated in FIG. 14). The processes already described above will be identified by the same step numbers in FIG. 24, and detailed descriptions thereof will be omitted below.

In step S2401, the form generation server 101 performs processing for acquiring the value of each pieces of output data related to the graph. More specifically, the form generation server 101 searches for the information of the output data generated from the field identified in step S1405 (hereinafter referred to as a related field) from the output page information 2300. The form generation server 101 identifies the output data having the “field name” (field_name) matching the field name of the related field of the graph in the output data information block 2302 in the output page information 2300, and acquires a value of the “actual data” (data) 2301 thereof. The graph is generated using the output data acquired in step S1401. This is the graph generation processing according to the second exemplary embodiment.

Since the output data is not present on the output page SVG in the second exemplary embodiment, the information processing system can neither perform the processing for updating the output data from the touch operation like step S1905. Regarding this inconvenience, the information processing system can also receive an operation of the user and update the graph according to a content of the operation of the user by providing an option selection user interface 2201 or the like on a screen display illustrated in FIG. 22. The option selection user interface 2201 can be realized by a JavaScript program. For example, in a case where an option “15%” is selected on the option selection user interface 2201 by the operation of the user, the JavaScript program updates the graph by reducing the value of each pieces of output data displayed on the graph by 15%.

### OTHER EMBODIMENTS

In the above-described exemplary embodiments, the “touch operation”, which is the user operation onto the screen display, has not been described in detail, but specifically how the touch operation is performed, such as a swipe and a tap, is not limited.

The above-described exemplary embodiments have been described assuming that the table displayed on the client apparatus 102 serves as the “form” for convenience of the description, but the table may be provided in any manner as long as it is configured as a table (or a chart).

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2017-238086, filed Dec. 12, 2017, which is hereby incorporated by reference herein in its entirety.

What is claimed is:

1. An information processing system comprising:
a client apparatus including a web browser, and
a form generation server configured to provide a form displayed on a screen of the client apparatus by the web browser, the form including a table and a graph, the graph being generated in correspondence with output data contained in the table and a field that is an element of the output data,
wherein the form generation server includes a provision unit for identifying a position of the output data that is specified by a user on the screen displayed by the web browser, and updating the graph currently displayed on the screen according to a change in the output data, and
wherein the web browser of the client apparatus functions as
a determination unit configured to identify the graph related to the changed output data and determine whether the field contained in the identified graph and the field at the position match each other, and
a change unit configured to change the display of the graph based on the output data changed by a user operation according to the determination unit determining that the field contained in the identified graph and the field at the position match each other.

2. The information processing system according to claim 1, wherein, in a case where the determination unit determines that the field contained in the identified graph and the field at the position do not match each other, the information processing system ends processing without updating the display of the graph by the change unit.

3. The information processing system according to claim 1, wherein the program includes
first output page information containing information of a layout of the table and the graph included in the form, and
second output page information containing a drawing element drawn on the screen and information of a drawing position of the drawing element, the second output page information being generated as a result of a change of the first output page information into a file format different from the first output page information.

4. The information processing system according to claim 3, wherein the first output page information includes
a first page block being information of a layout of the table included in the form in a specific output page, and
a second page block containing information of a layout of the graph related to the first page block and an identifier of the graph.

5. The information processing system according to claim 4, wherein, after confirming that the second page block is included in the first output page information of the form currently displayed on the screen, the determination unit identifies a graph attribute containing the field of the graph based on the identifier of the graph contained in the second page block, and determines whether the field contained in the identified graph attribute and the field at the position match each other.

6. The information processing system according to claim 5, wherein, in a case where the determination unit confirms that the second page block is not included in the first output page information of the form currently displayed on the screen, the change unit changes the display of the table included in the form based on the output data changed by the user operation.

7. The information processing system according to claim 1, wherein the web browser of the client apparatus executing the program provided by the provision unit further includes a second determination unit configured to determine whether the field is present at the position of the output data that is specified by the user, and displays a dialog for changing the output data by the user operation in a case where the second determination unit determines that the field is present at the position and ends the processing without displaying the dialog in a case where the second determination unit determines that the field is not present at the position.

8. The information processing system according to claim 7, further comprising:
a third determination unit configured to determine whether a drawing position of a drawing element is contained in a layout of the table using first output page information containing information of the layout of the table and second output page information containing information of the drawing position of the drawing element drawn on the screen; and
an assignment unit configured to assign a field name of the field and identification information to the drawing element contained in the second output page information according to the third determination unit determining that the drawing position of the drawing element is contained in the layout of the table,
wherein the second determination unit determines whether the field is present at the position of the output data that is specified by the user using the field name assigned by the assignment unit.

9. The information processing system according to claim 8, wherein, after the first output page information is confirmed to include a second page block, a graph attribute containing the field of the graph is identified based on an identifier of the graph contained in the second page block, and the graph is generated using the graph attribute and the second output page information with the field name and the identification information assigned thereto by the assignment unit.

10. The information processing system according to claim 1, wherein the web browser further includes a generation unit configured to generate the graph based on first output page information containing information of a layout of the table and the graph and a drawing element in a case where there does not exist second output page information containing the drawing element drawn on the screen and information of a drawing position of the drawing element.

11. A method for controlling a client apparatus configured to display a form on a screen of the client apparatus by a web browser, the form including a table and a graph, the graph being generated in correspondence with output data contained in the table and a field that is an element of the output data, the method comprising:
causing the web browser of the client apparatus to, when executing a program for identifying a position of the output data that is specified by a user on the screen displayed by the web browser and updating the graph currently displayed on the screen according to a change in the output data, perform
determining, after identifying the graph related to the changed output data, whether the field contained in the identified graph and the field at the position match each other, and
changing the display of the graph based on the output data changed by a user operation according to the determination that the field contained in the identified graph and the field at the position match each other.

12. A non-transitory storage medium storing instructions that when executed by one or more processors controls the one or more processors to operate as a client apparatus configured to display a form on a screen of the client apparatus by a web browser,
wherein the form includes a table and a graph, and the graph is generated in correspondence with output data contained in the table and a field that is an element of the output data, and
wherein, when executing a program for identifying a position of the output data that is specified by a user on the screen displayed by the web browser and updating the graph currently displayed on the screen according to a change in the output data, the web browser of the client apparatus functions as
a determination unit configured to identify the graph related to the changed output data and determine whether the field contained in the identified graph and the field at the position match each other, and
a change unit configured to change the display of the graph based on the output data changed by a user operation according to the determination unit determining that the field contained in the identified graph and the field at the position match each other.
